(19) United States
(12) Patent Application Publication
(10) Pub. No.: US 2024/0202002 A1
(43) Pub. Date: Jun. 20, 2024

(54) METHODS AND APPARATUSES FOR INSTRUCTIONS INCLUDING A MISPREDICTION HANDLING HINT TO REDUCE A BRANCH MISPREDICTION PENALTY

(71) Applicant: INTEL CORPORATION, SANTA CLARA, CA (US)

(72) Inventor: Hideki Ido, Campbell, CA (US)

(21) Appl. No.: 18/067,577

(22) Filed: Dec. 16, 2022

(51) Int. Cl. G06F 9/38; G06F 9/30

(52) U.S. Cl. CPC G06F 9/3842; G06F 9/30145

(57) ABSTRACT

Techniques for implementing a branch instruction having a misprediction handling hint to prevent instructions on a mispredicted path from getting cancelled are described. In certain examples, a hardware processor core includes a retirement circuit; a branch predictor circuit to predict a predicted path for a branch, and cause a speculative processing of the predicted path; a decode circuit to decode a single instruction into a decoded instruction, the single instruction having a field to indicate the retirement circuit is to allow retirement of the predicted path for the branch that is a misprediction; and an execution circuit to execute the decoded instruction to cause: the retirement circuit to allow the retirement of the predicted path that is the misprediction for the branch when the field is set to a first value, and the retirement circuit to disallow the retirement of the predicted path that is the misprediction for the branch when the field is otherwise.

### BACKGROUND

A processor, or set of processors, executes instructions from an instruction set, e.g., the instruction set architecture (ISA). The instruction set is the part of the computer architecture related to programming, and generally includes the native data types, instructions, register architecture, addressing modes, memory architecture, and exception handling, and external input and output (IO). It should be noted that the term instruction herein may refer to a macro-instruction, e.g., an instruction that is provided to the processor for execution, or to a micro-instruction, e.g., an instruction that results from a processor's decoder decoding macroinstructions.

### BRIEF DESCRIPTION OF DRAWINGS

The patent or application file contains at least one drawing executed in color. Copies of this patent or patent application publication with color drawing(s) will be provided by the Office upon request and payment of the necessary fee.

Various examples in accordance with the present disclosure will be described with reference to the drawings, in which:

FIG. 1 illustrates a block diagram of a computer system including at least one core having a branch predictor and a plurality of processing phases according to examples of the disclosure.

FIG. 2 illustrates first code that includes a loop with a conditional computation and second code that is a (e.g., naively) vectorized version of the first code according to examples of the disclosure.

FIG. 3 illustrates code that includes vectorized code that includes a mask-all-zeros bypass according to examples of the disclosure.

FIG. 4 illustrates code that includes vectorized code that includes mask-all-ones multi-versioning according to examples of the disclosure.

FIG. 5 illustrates first scalar code and second code that includes a conditional computation version of the first code according to examples of the disclosure.

FIG. 6 illustrates first scalar code, second code that includes a predicated version of the first code, and a third code that includes a conditional computation version of the second code according to examples of the disclosure.

FIG. 7 illustrates code that includes vectorized code that includes a mask-all-zeros bypass that is safe to execute even if the mask is all false according to examples of the disclosure.

FIG. 8 illustrates code that includes vector iterations that include a conditional instruction (e.g., a conditional jump instruction with the mnemonic of JZ) according to examples of the disclosure.

FIG. 9 illustrates handling of a misprediction of a conditional instruction of the code in FIG. 7 without utilizing a field (e.g., a misprediction handling hint) of an instruction (e.g., conditional jump instruction “JZ”) according to examples of the disclosure.

FIG. 10 illustrates handling of a misprediction of a conditional instruction of the code in FIG. 7 by utilizing a field (e.g., a misprediction handling hint) of an instruction according to examples of the disclosure.

FIG. 11 illustrates examples of computing hardware to process a (e.g., conditional) branch instruction with a misprediction handling hint.

FIG. 12 illustrates an example method performed by a processor to process a (e.g., conditional) branch instruction with a misprediction handling hint.

FIG. 13 illustrates an example method to process a (e.g., conditional) instruction with a misprediction handling hint using emulation or binary translation.

FIG. 14 illustrates handling of a misprediction of a conditional instruction without utilizing a field (e.g., a misprediction handling hint) of the conditional instruction for a code section having a path A to “IF” guarded code from the conditional instruction, a path B to subsequent code from the “IF” guarded code, and a path C to the subsequent code from the conditional instruction.

FIG. 15 illustrates handling of a misprediction of a conditional instruction (e.g., “JCC MH²”) by utilizing a “optional cancel for not-taken” (e.g., cancellation_is_optional_if_mispredicted_towards_not-taken) field (e.g., a misprediction handling hint) of the conditional instruction for a code section having a path A to “IF” guarded code from the conditional instruction, a path B to subsequent code from the “IF” guarded code, and a path C to the subsequent code from the conditional instruction.

FIG. 16 illustrates handling of a misprediction of a conditional instruction (e.g., “JCC_MH²”) by utilizing a “optional cancel for taken” (e.g., cancellation_is_optional_if_mispredicted_towards_taken) field (e.g., a misprediction handling hint) of the conditional instruction for a code section having a path A to “IF” guarded code from the conditional instruction, a path B to subsequent code from the “IF” guarded code, and a path C to the subsequent code from the conditional instruction.

FIG. 17 illustrates an example computing system.

FIG. 18 illustrates a block diagram of an example processor and/or System on a Chip (SoC) that may have one or more cores and an integrated memory controller.

FIG. 19A is a block diagram illustrating both an example in-order pipeline and an example register renaming, out-of-order issue/execution pipeline according to examples.

FIG. 19B is a block diagram illustrating both an example in-order architecture core and an example register renaming, out-of-order issue/execution architecture core to be included in a processor according to examples.

FIG. 20 illustrates examples of execution unit(s) circuitry.

FIG. 21 is a block diagram of a register architecture according to some examples.

FIG. 22 illustrates examples of an instruction format.

FIG. 23 illustrates examples of an addressing information field.

FIG. 24 illustrates examples of a first prefix.

FIGS. 25A-D illustrate examples of how the R, X, and B fields of the first prefix in FIG. 24 are used.

FIGS. 26A-B illustrate examples of a second prefix.

FIG. 27 illustrates examples of a third prefix.

FIG. 28 is a block diagram illustrating the use of a software instruction converter to convert binary instructions in a source instruction set architecture to binary instructions in a target instruction set architecture according to examples.

### DETAILED DESCRIPTION

The present disclosure relates to methods, apparatus, systems, and non-transitory computer-readable storage media that utilize a misprediction handling hint to reduce a branch misprediction penalty for a processor.

In the following description, numerous specific details are set forth. However, it is understood that examples of the disclosure may be practiced without these specific details. In other instances, well-known circuits, structures, and techniques have not been shown in detail in order not to obscure the understanding of this description.

References in the specification to “one example,” “an example,” “examples,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

A (e.g., hardware) processor (e.g., having one or more cores) may execute instructions (e.g., a thread of instructions) to operate on data, for example, to perform arithmetic, logic, or other functions. For example, software may request an operation and a hardware processor (e.g., a core or cores thereof) may perform the operation in response to the request. The software may include one or more branches (e.g., branch instructions) that cause the execution of a different instructions sequence than in program order. A branch instruction may be an unconditional branch, which always results in branching, or a conditional branch, which may or may not cause branching depending on some condition(s). Certain processors are pipelined to allow more instructions to be completed faster, for example, so that instructions do not wait for the previous ones to complete before their execution begins. A problem with this approach arises, however, due to conditional branches. Particularly, when the processor encounters a conditional branch and the result for the condition has not yet been calculated, it does not know whether to take the branch or not. Branch prediction is what certain processors use to decide whether to take a conditional branch or not. Getting this information as accurately as possible is important, as an incorrect prediction (e.g., misprediction) will cause certain processors to throw out all the instructions that did not need to be executed and start over with the correct set of instructions, e.g., with this process being particularly expensive with (e.g., deeply) pipelined processors.

In certain examples, a processor (e.g., processor core) has one or more pipelines that include fetch, decode, execute, and retire (e.g., write back) stages (e.g., where an instruction is fetched, then decoded, then executed, and finally retired). In certain examples, this process occurs concurrently between adjacent instructions, e.g., while one instruction is retiring, another instruction (e.g., next in program order) is executing, yet another instruction (e.g., next in program order) is decoding, and even another instruction (e.g., next in program order) is being fetched. In certain examples, when a branch (e.g., branch instruction) reaches the execution stage, it changes what instruction will be executed next, and thus certain of those other instructions in the pipeline (e.g., at fetch and/or decode) are to be cancelled (e.g., and the speculative work thus discarded).

In certain examples, a branch predictor (e.g., stage) is included (e.g., ahead of the fetch stage) that predicts where the branches might be and/or predicts whether conditional branches are going to be “taken” or “not-taken”. In certain examples, a conditional (e.g., IF) branch (e.g., conditional branch instruction) includes a first “taken” path if the condition is true (e.g., the condition evaluates to a logical one) and a second “not-taken” path if the condition is false (e.g., the condition evaluates to a logical zero). In certain examples, a branch predictor is to predict (e.g., based on previous execution history of the processor) if the conditional (e.g., IF) branch (e.g., conditional branch instruction) will follow the first “taken” path (e.g., predict the condition is true) (e.g., the predicted taken path) or will follow the second “not-taken” (e.g., predict the condition is false) (e.g., the predicted not-taken path). In certain example, the prediction is checked against the actual outcome of the branch instruction (e.g., comparison of the result (e.g., condition) of the executed branch instruction against the predicted result), e.g., and the speculative processing of the subsequent instruction is kept if the prediction was correct and discarded (e.g., re-steered) if the prediction was incorrect. Examples of a Jump if Condition Is Met instruction (Jcc instruction) are discussed below.

Certain (e.g., out-of-order (OoO)) processors heavily rely on branch prediction mechanisms in order to keep the processors' processing (e.g., execution) pipeline from stalling due to conditional branches. In certain examples, a processor has numerous (e.g., 100 or more) subsequent instructions in-flight by the time the actual outcome of a conditional branch (e.g., Jcc) instruction is finally decided, e.g., when the conditional branch (e.g., Jcc) instruction reaches the execution stage. This is beneficial when the branch prediction is mostly correct, but unfortunately that is not always the case. In certain examples, branch mispredictions are handled by cancelling all speculated instructions that were fetched and/or decoded after (e.g., in program order) the conditional branch (e.g., Jcc) instruction. Thus, in certain processors, there is a misprediction penalty caused by the time spent to cancel a mispredicted path and resteer the processing to the correct path, e.g., where the processing of an instruction includes multiple (e.g., 10 or more) stages between a fetch circuit and an execution circuit.

However, some of those cancelled instructions are later processed (e.g., fetched, decoded, and executed) again, for example, because they belong to a block of code after the confluence point of the correct code path and the mispredicted code path, e.g., not control dependent on the conditional branch (e.g., Jcc) instruction. In certain examples, architects (e.g., micro-architects) do not attempt to salvage such useful instructions from getting cancelled because the cost of capitalizing such opportunities is considered prohibitively high.

To overcome these problems, examples herein are directed to a processor that supports a conditional branch instruction with misprediction handling field (e.g., hint), e.g., that uses the misprediction handling field (e.g., hint) to prevent those useful instructions on a mispredicted path from getting cancelled and thus improves the performance and power efficiency of the processor by utilizing the processing work (e.g., fetch, decode, etc.) that has already been expended for the mispredicted path. In certain examples, this instruction is a conditional jump instruction (Jcc) with misprediction handling field (e.g., hint) (e.g., a Jcc with misprediction handling hint (e.g., having a mnemonic of Jcc_MH²)). In certain examples, the conditional branch instruction with misprediction handling field (e.g., hint) includes the novel functionality of continuing and retiring instructions along the mispredicted (and thus “incorrect”) path, e.g., instead of cancelling all mis-speculated instructions. For example, there is a class of branches (e.g., inserted by programmers/compilers) for choosing the more performant path that is valid when a certain condition is met. For such branches, executing the less performant (e.g., vector) code path, even when more performant (e.g., vector) code path can be taken, is still perfectly valid from the software execution perspective. In certain examples, the conditional branch instruction with misprediction handling field (e.g., hint) allows the mispredicted (e.g., less performant) code path to finish (e.g., retire), for example, to reduce a branch misprediction penalty, e.g., where finishing the mispredicted (e.g., less performant) code path is faster than cancelling it and processing (e.g., fetching, decoding, etc.) the correct (e.g., more performant) code path (e.g., from scratch).

In certain examples, allowing execution to continue along a mispredicted path via a corresponding hint is used for a multiple-way (e.g., 3 or more way) branch instruction, for example, to allow a mispredicted (e.g., less performant) way to finish (e.g., retire). In certain examples, the multiple-way branch is a two-way conditional branch (e.g., hint value is based on taken/not taken misprediction) or a branch instruction with multiple target specification (e.g., in the operand) (e.g., hint value is based on mispredicted target (e.g., operand position)).

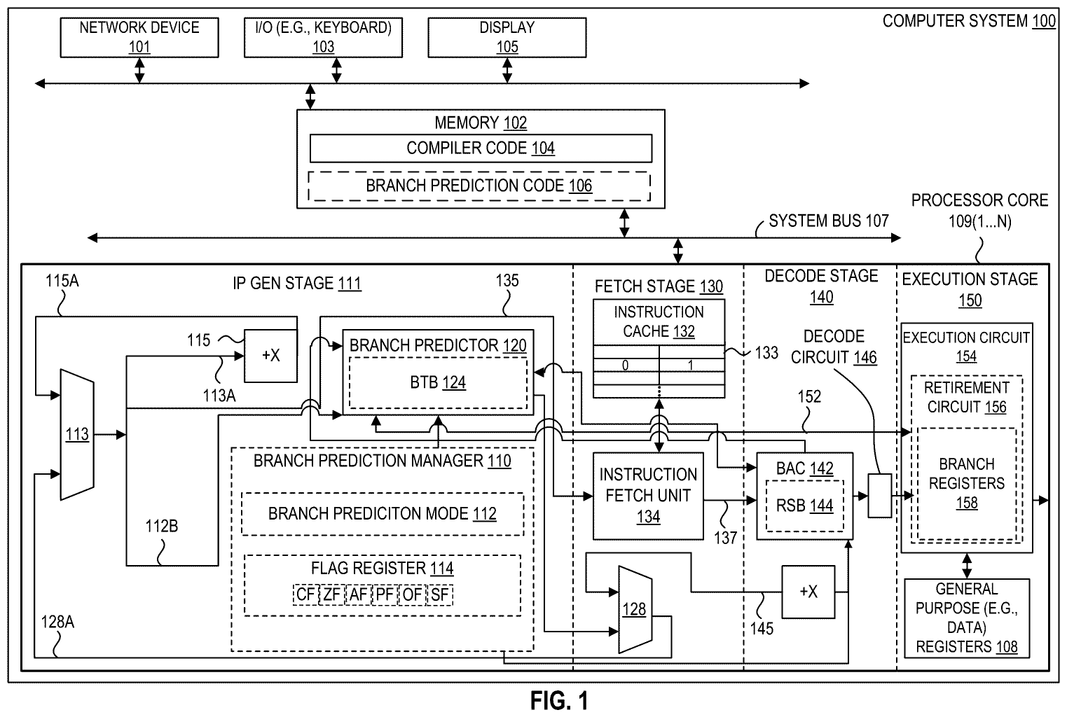

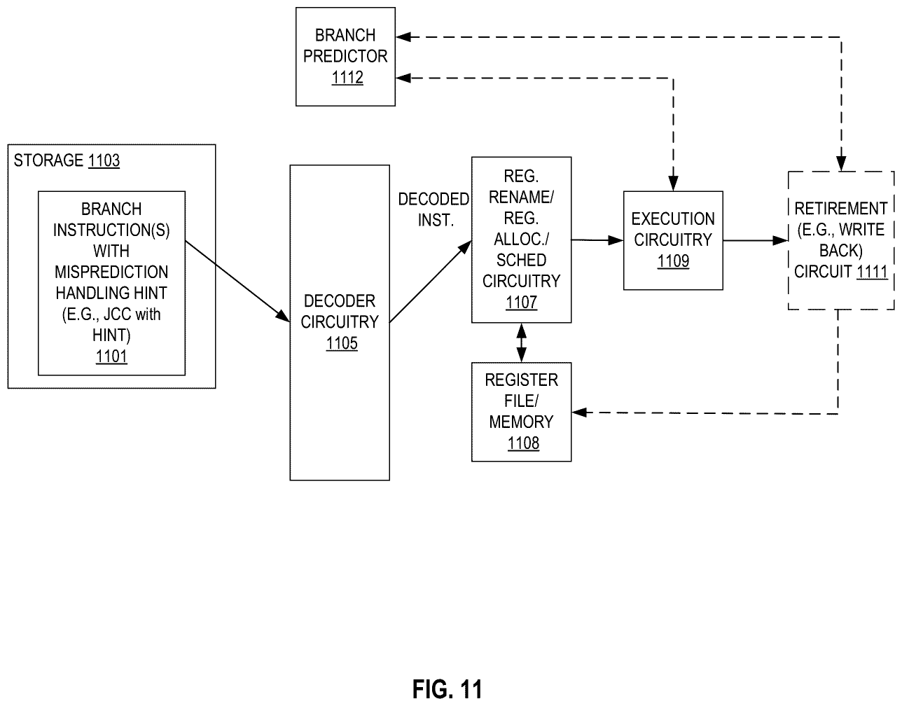

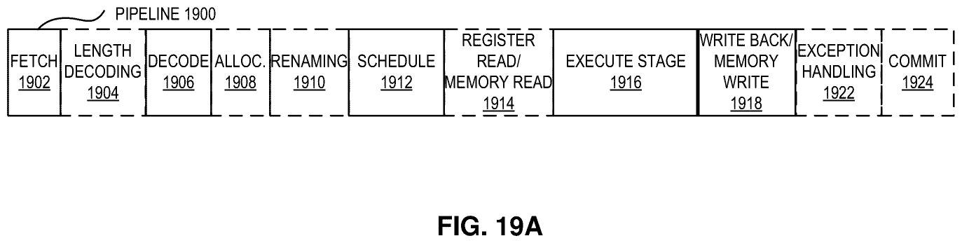

Turning now to FIG. 1, an example computer system architecture is depicted. Although branch predictor 120 is discussed in reference to the architecture in FIG. 1, it should be understood that other architectures may include a branch predictor and those architectures may be improved by adding the functionality discussed herein. For example, the branch predictor 1932 shown in FIG. 19B may be controlled (e.g., allowing or disallowing certain functionality) by a conditional jump instruction with misprediction handling field (e.g., hint) (e.g., a Jcc_MH² instruction) disclosed herein. In certain examples, a computer system's (e.g., processor's) architecture includes a branch predictor that (e.g., for a mispredicted condition of a conditional jump instruction) sends control indications to multiple parts of a processing pipeline, e.g., to cancel all subsequent instructions that are already fetched (e.g., where some are decoded, some are executed, etc.). In certain examples, a conditional jump instruction includes a misprediction handling field (e.g., hint) that prevents those control indications from being sent to those multiple parts of a processing pipeline and/or prevents sent control indications from reaching those multiple parts of a processing pipeline. As one example, (i) a conditional instruction without a misprediction handling field or (ii) a conditional instruction with a misprediction handling field set to indicate the system is to perform cancellation along the mispredicted (and thus “incorrect”) path sends a control value to IP GEN Stage 111 such that Instruction Fetch Unit 134 will fetch an instruction from the “properly resolved” branch target, but (iii) a conditional instruction with a misprediction handling field set to indicate the system is to not perform cancellation along the mispredicted (and thus “incorrect”) path (e.g., the system is to allow execution along the mispredicted path to continue through retiring the instructions along the mispredicted path) does not send such a control value to IP GEN Stage 111 to cause the Instruction Fetch Unit 134 to fetch an instruction from the “properly resolved” branch target. In certain examples, execution circuit 154 (or execution circuitry 1109) sends control values to cause cancellation (e.g., to 1111, 1109, 1107, 1105, and 1103 in FIG. 11) in response to the execution of (i) a conditional instruction without a misprediction handling field or (ii) a conditional instruction with a misprediction handling field set to indicate the system is to perform cancellation along the mispredicted path; but does not sent those control values in response to the execution of (iii) a conditional instruction with a misprediction handling field set to indicate the system is to not perform cancellation along the mispredicted (and thus “incorrect”) path.

In certain examples, this is implemented in a “jump execution circuit” of execution circuitry 1109.

In certain examples, a conditional instruction with a misprediction handling field set to indicate the system is to not perform cancellation along the mispredicted (and thus “incorrect”) path causes the system (e.g., processor) to continue executing as if misprediction was not detected. In certain examples, this “not perform cancellation” includes not sending control values that would otherwise be sent.

In certain examples, when the system (e.g., processor) executes a conditional instruction with a misprediction handling field set to indicate the system is to not perform cancellation along the mispredicted (and thus “incorrect”) path, the branch predictor 120 is still notified that misprediction happened, e.g., to improve any future predictions.

FIG. 1 illustrates a block diagram of a computer system 100 including at least one core 109 having a branch predictor 120 and a plurality of processing phases (e.g., instruction pointer generation stage 111, fetch stage 130, decode stage 140, execution stage 150, etc.) according to examples of the disclosure. In certain examples, processor core 109 may include a branch predictor 120 (e.g., and include a branch prediction manager 110 to manage the functionality discussed herein). Depicted computer system 100 includes a branch predictor 120 and a branch address calculator 142 (BAC) in a pipelined processor core 109(1)-109(N) according to examples of the disclosure. In certain examples, a pipelined processor core (e.g., 109(1)) includes an instruction pointer generation (IP Gen) stage 111, a fetch stage 130, a decode stage 140, and an execution stage 150. In certain examples, a retirement stage (e.g., including a retirement circuit 156 (e.g., including a re-order buffer (ROB)) follows execution stage 150. In certain examples, system 100 includes branch registers 158 (e.g., branch registers b0-b7) that store the address of a code location that the processor can transfer control to.

In certain examples, computer system 100 (e.g., processor thereof) includes multiple cores 109(1-N), where N is any positive integer. In another example, computer system 100 (e.g., processor thereof) includes a single core. In certain examples, cach processor core 109(1-N) instance supports multithreading (e.g., executing two or more parallel sets of operations or threads on a first and second logical core), and may do so in a variety of ways including time sliced multithreading, simultaneous multithreading (e.g., where a single physical core provides a logical core for each of the threads that physical core is simultaneously multithreading), or a combination thereof (e.g., time sliced fetching and decoding and simultaneous multithreading thereafter). In the depicted example, each single processor core 109(1) to 109(N) includes an instance of branch predictor 120. Branch predictor 120 may include a branch target buffer (BTB) 124.

In certain examples, branch target buffer 124 stores (e.g., in a branch predictor array) the predicted target instruction corresponding to each of a plurality of branch instructions (e.g., branch instructions of a section of code that has been executed multiple times). In the depicted example, a branch address calculator (BAC) 142 is included which accesses (e.g., includes) a return stack buffer 144 (RSB). In certain examples, return stack buffer 144 is to store (e.g., in a stack data structure of last data in is the first data out (LIFO)) the return addresses of any CALL instructions (e.g., that push their return address on the stack).

Branch address calculator (BAC) 142 is used to calculate addresses for certain types of branch instructions and/or to verify branch predictions made by a branch predictor (e.g., BTB). In certain examples, the branch address calculator performs branch target and/or next sequential linear address computations. In certain examples, the branch address calculator performs static predictions on branches based on the address calculations.

In certain examples, the branch address calculator 142 contains a return stack buffer 144 to keep track of the return addresses of CALL instructions. In one example, the branch address calculator attempts to correct any improper prediction made by the branch predictor 120 to reduce branch misprediction penalties. As one example, the branch address calculator verifies branch prediction for those branches whose target can be determined solely from the branch instruction and instruction pointer.

In certain examples, the branch address calculator 142 maintains the return stack buffer 144 utilized as a branch prediction mechanism for determining the target address of return instructions, e.g., where the return stack buffer operates by monitoring all “call subroutine” and “return from subroutine” branch instructions. In one example, when the branch address calculator detects a “call subroutine” branch instruction, the branch address calculator pushes the address of the next instruction onto the return stack buffer, e.g., with a top of stack pointer marking the top of the return stack buffer. By pushing the address immediately following each “call subroutine” instruction onto the return stack buffer, the return stack buffer contains a stack of return addresses in this example. When the branch address calculator later detects a “return from subroutine” branch instruction, the branch address calculator pops the top return address off of the return stack buffer, e.g., to verify the return address predicted by the branch predictor 120. In one example, for a direct branch type, the branch address calculator is to (e.g., always) predict taken for a conditional branch, for example, and if the branch predictor does not predict taken for the direct branch, the branch address calculator overrides the branch predictor's missed prediction or improper prediction.

Additionally (or alternatively) to this branch prediction, in certain examples the branch predictor 120 is to predict whether to take a conditional branch or not, e.g., to use to speculatively process (e.g., fetch, decode, etc.) a set of one or more instructions along the speculated path. In certain examples, the system 100 is to speculatively process (e.g., fetch, decode, etc.) the predicted path (e.g., because the actual path is not known at the time of prediction) of a pair of (i) a taken path and (ii) a not-taken path. As discussed herein, that speculation may turn out to be incorrect, but examples herein allow a processor to prevent those useful instruction(s) on a mispredicted path from getting cancelled (e.g., allow them to execute and/or retire).

The core 109 in FIG. 1 includes circuitry to validate branch predictions made by the branch predictor 120. Each branch predictor 120 entry (e.g., in BTB 124) may further includes a valid field and a bundle address (BA) field which are used to increase the accuracy and validate branch predictions performed by the branch predictor 120, as is discussed in more detail below. In one example, the valid field and the BA field each consist of one bit fields. In other examples, however, the size of the valid and BA fields may vary. In one example, a fetched instruction is sent (e.g., by BAC 142 from line 137) to the decoder 146 to be decoded, and the decoded instruction is sent to the execution unit 154 to be executed.

Depicted computer system 100 includes a network device 101, input/output (I/O) circuit 103 (e.g., keyboard), display 105, and a system bus (e.g., interconnect) 107.

In one example, the branch instructions stored in the branch predictor 120 are pre-selected by a compiler as branch instructions that will be taken. In certain examples, the compiler code 104, as shown stored in the memory 102 of FIG. 1, includes a sequence of code that, when executed, translates source code of a program written in a high-level language into executable machine code. In one example, the memory 102 (e.g., compiler code) further includes branch predictor code 106 that predicts a target instruction for branch instructions (for example, branch instructions that are likely to be taken (e.g., pre-selected branch instructions)) and/or a predicted path for a conditional instruction. In certain examples, the branch predictor 120 (e.g., BTB 124 thereof) is thereafter updated with target instruction for a branch instruction. In one example, software manages a hardware BTB, e.g., with the software specifying the prediction mode or with the prediction mode defined implicitly by the mode of the instruction that writes the BTB also setting a mode bit in the entry.

As discussed below, depicted core (e.g., branch predictor 120 thereof) includes access to one or more registers. In certain examples, core include one or more general purpose (e.g., data) register(s) 108 and/or one or more flag registers 114.

In certain examples, each entry for the branch predictor 120 (e.g., in BTB 124 thereof) includes a tag field and a target field. In one example, the tag field of each entry in the BTB stores at least a portion of an instruction pointer (e.g., memory address) identifying a branch instruction. In one example, the tag field of each entry in the BTB stores an instruction pointer (e.g., memory address) identifying a branch instruction in code. In one example, the target field stores at least a portion of the instruction pointer for the target of the branch instruction identified in the tag field of the same entry. Moreover, in other example, the entries for the branch predictor 120 (e.g., in BTB 124 thereof) includes one or more other fields. In certain examples, an entry does not include a separate field to assist in the prediction of whether the branch instruction is taken, e.g., if a branch instruction is present (e.g., in the BTB), it is considered to be taken.

As shown in FIG. 1, the IP Gen mux 113 of IP generation stage 111 receives an instruction pointer from line 115A. The instruction pointer provided via line 115A is generated by the incrementer circuit 115, which receives a copy of the most recent instruction pointer from the path 113A. The incrementer circuit 115 may increment the present instruction pointer by a predetermined amount, to obtain the next sequential instruction from a program sequence presently being executed by the core.

In one example, upon receipt of the IP from IP Gen mux 113, the branch predictor 120 compares (e.g., a portion of) the IP with the tag field of each entry in the branch predictor 120 (e.g., BTB 124). If no match is found between the IP and the tag fields of the branch predictor 120, the IP Gen mux will proceed to select the next sequential IP as the next instruction to be fetched in this example. Conversely, if a match is detected, the branch predictor 120 reads the valid field of the branch predictor entry which matches with the IP. If the valid field is not set (e.g., has logical value of 0) the branch predictor 120 considers the respective entry to be “invalid” and will disregard the match between the IP and the tag of the respective entry in this example, e.g., and the branch target of the respective entry will not be forwarded to the IP Gen Mux. On the other hand, if the valid field of the matching entry is set (e.g., has a logical value of 1), the branch predictor 120 proceeds to perform a logical comparison between a predetermined portion of the instruction pointer (IP) and the branch address (BA) field of the matching branch predictor entry in this example. If an “allowable condition” is present, the branch target of the matching entry will be forwarded to the IP Gen mux, and otherwise, the branch predictor 120 disregards the match between the IP and the tag of the branch predictor entry. In some examples, the entry indicator is formed from not only the current branch IP, but also at least a portion of the global history.

More specifically, in one example, the BA field indicates where the respective branch instruction is stored within a line of cache memory 132. In certain examples, a processor is able to initiate the execution of multiple instructions per clock cycle, wherein the instructions are not interdependent and do not use the same execution resources.

For example, each line of the instruction cache 132 shown in FIG. 1 includes multiple instructions (e.g., six instructions). Moreover, in response to a fetch operation by the fetch unit 134, the instruction cache 132 responds (e.g., in the case of a “hit”) by providing a full line of cache to the fetch unit 134 in this example. The instructions within a line of cache may be grouped as separate “bundles.” For example, as shown in FIG. 1, the first three instructions in a cache line 133 may be addressed as bundle 0, and the second three instructions may be address as bundle 1. Each of the instructions within a bundle are independent of each other (e.g., can be simultaneously issued for execution). The BA field provided in the branch predictor 120 entries is used to identify the bundle address of the branch instruction which corresponds to the respective entry in certain examples. For example, in one example, the BA identifies whether the branch instruction is stored in the first or second bundle of a particular cache line.

In one example, the branch predictor 120 performs a logical comparison between the BA field of a matching entry and a predetermined portion of the IP to determine if an “allowable condition” is present. For example, in one example, the fifth bit position of the IP (e.g., IP[4]) is compared with the BA field of a matching (e.g., BTB) entry. In one example, an allowable condition is present when IP [4] is not greater than the BA. Such an allowable condition helps prevent the apparent unnecessary prediction of a branch instruction, which may not be executed. That is, when less than all of the IP is considered when doing a comparison against the tags of the branch predictor 120, it is possible to have a match with a tag, which may not be a true match. Nevertheless, a match between the IP and a tag of the branch predictor indicates a particular line of cache, which includes a branch instruction corresponding to the respective branch predictor entry, may about to be executed. Specifically, if the bundle address of the IP is not greater than the BA field of the matching branch predictor entry, then the branch instruction in the respective cache line is soon to be executed. Hence, a performance benefit can be achieved by proceeding to fetch the target of the branch instruction in certain examples.

As discussed above, if an “allowable condition” is present, the branch target of the matching entry will be forwarded to the IP Gen mux 113 in this example. Otherwise, the branch predictor will disregard the match between the IP and the tag. In one example, the branch target forwarded from the branch predictor is initially sent to a Branch Prediction (BP) resteer mux 128, before it is sent to the IP Gen mux. The BP resteer mux 128, as shown in FIG. 1, may also receive instruction pointers from other branch prediction devices. In one example, the input lines received by the BP resteer mux will be prioritized to determine which input line will be allowed to pass through the BP resteer mux onto the IP Gen mux.

In addition to forwarding a branch target to the BP resteer mux, upon detecting a match between the IP and a tag of the branch predictor, the BA of the matching branch predictor entry is forwarded to the Branch Address Calculator (BAC) 142. The BAC 142 is shown in FIG. 1 to be located in the decode stage 140, but may be located in other stage(s). The BAC 142 may also receive a cache line from the fetch unit 134 via line 137.

The IP selected by the IP Gen mux is also forwarded to the fetch unit 134, via data line 135 in this example. Once the IP is received by the fetch unit 134, the cache line corresponding to the IP is fetched from the instruction cache 132. The cache line received from the instruction cache is forwarded to the BAC, via data line 137.

Upon receipt of the BA in this example, the BAC will read the BA to determine where the pre-selected branch instruction (e.g., identified in the matching branch predictor entry) is located in the next cache line to be received by the BAC (e.g., the first or second bundle of the cache line). In one example, it is predetermined where the branch instruction is located within a bundle of a cache line (e.g., in a bundle of three instructions, the branch instruction will be stored as the second instruction).

In alternative examples, the BA includes additional bits to more specifically identify the address of the branch instruction within a cache line. Therefore, the branch instruction would not be limited to a specific instruction position within a bundle.

After the BAC determines the address of the pre-selected branch instruction within the cache line, and has received the respective cache line from the fetch unit 134, the BAC will decode the respective instruction to verify the IP truly corresponds to a branch instruction. If the instruction addressed by BA in the received cache line is a branch instruction, no correction for the branch prediction is necessary. Conversely, if the respective instruction in the cache line is not a branch instruction (i.e., the IP does not correspond to a branch instruction), the BAC will send a message to the branch predictor to invalidate the respective branch predictor entry, to prevent similar mispredictions on the same branch predictor entry. Thereafter, the invalidated branch predictor entry will be overwritten by a new branch predictor entry.

In addition, in one example, the BAC will increment the IP by a predetermined amount and forward the incremented IP to the BP resteer mux 128, via data line 145, e.g., the data line 145 coming from the BAC will take priority over the data line from the branch predictor. As a result, the incremented IP will be forwarded to the IP Gen mux and passed to the fetch unit in order to correct the branch misprediction by fetching the instructions that sequentially follow the IP.

Additionally or alternatively, in certain examples, a branch prediction manager 110 (e.g., circuit) allows (or does not allow) predication of predictions, e.g., to selectively predicate a prediction to instead provide (e.g., fetch) both the predicted to-be-taken and the predicted not-to-be-taken portions of a conditional branch, but the final execution is dependent on the branch outcome.

In certain examples, system 100 (e.g., core 109) supports a conditional branch instruction with misprediction handling field (e.g., hint) (e.g., Jcc_MH² instruction) that uses the misprediction handling field (e.g., hint) to prevent instructions on a mispredicted path from getting cancelled. In certain examples, system 100 (e.g., via core 109 executing a conditional branch instruction with misprediction handling field) is switchable between a first mode that allows branch predictor 120 to cancel processing of instructions (e.g., prevents retirement of those instructions) on a mispredicted path of a conditional branch and a second mode that disallows branch predictor 120 to cancel processing of the instructions (e.g., allows retirement of those instructions) on the mispredicted path of a conditional branch. In certain examples, this behavior (e.g., mode selection) is controlled by branch prediction manager 110, e.g., by writing a value from the misprediction handling field (or data based on the misprediction handling field) into the branch prediction mode 112 (e.g., register). In certain examples, the branch predictor 120 sends a value (e.g., along path 152) to retirement circuit 156 to allow (or prevent) retirement of the (e.g., thread of) instructions of a mispredicted path of a conditional branch, e.g., based at least in part on the misprediction handling field (e.g., hint).

In certain examples, an execution circuit 154 (or some other component that executes a conditional jump) has only one mode of operation when the branch misprediction (e.g., for a conditional instruction without a misprediction handling field) is detected, e.g., cancel all subsequent mis-speculated instructions and restart from the correctly identified next IP.

In certain examples, an execution circuit 154 (or some other component that executes a conditional jump) has another (second) mode of operation when the branch misprediction (e.g., for a conditional instruction with a misprediction handling field) is detected, e.g., to not cancel the instructions of the misprediction and to also continue executing. In certain examples, this second mode is controlled by a hint within an instruction. In certain examples, an instruction supplied hint comes from the instruction 1101 in FIG. 11.

In certain examples, a conditional instruction is a Jump if Condition Is Met (e.g., Jcc) instruction. In certain examples, a conditional jump instruction includes a misprediction handling field (e.g., hint) (e.g., a Jcc with misprediction handling hint (e.g., having a mnemonic of Jcc_MH²)). In certain examples, the processing of a (e.g., Jcc) instruction checks the state of one or more of the status flags in a flag (e.g., EFLAGS) register (e.g., CF, ZF, AF, OF, or SF) and, if the flags are in the specified state (condition), performs a jump to the target instruction specified by the destination operand. In certain examples, a condition code (cc) is associated with each instruction to indicate the condition being tested for. In certain examples, if the condition is not satisfied, the jump is not performed and execution continues, e.g., with the instruction following the Jcc instruction in program order.

In certain examples, system 100 (e.g., core 109) includes a flag register 114. In certain examples, the flag register 114 includes a field (e.g., a single bit wide) for each flag therein. Flags may include one, all, or any combination of a carry flag (CF), a zero flag (ZF), an adjust flag (AF), a parity flag (PG), an overflow flag (OF), or a sign flag (SF). In certain examples, flag register 114 (e.g., only) includes six flags (e.g., CF, ZF, AF, PF, OF, and SF). In certain examples, cach flag is a single bit, e.g., with certain bits of the register not utilized. In certain examples, CF is in bit index zero of flag register 114, ZF is in bit index six of flag register 114, AF is in bit index four of flag register 114, PF is in bit index two of flag register 114, OF is in bit index eleven of flag register 114, and/or SF is in bit index seven of flag register 114. In certain examples, branch predictor 120 is to predict the value(s) in flag register 114, e.g., a prediction of a future time when the conditional instruction reaches execution).

In certain examples, flag register 114 is a single logical register, e.g., referenced as EFLAGS (e.g., 32 bits wide) or RFLAGS (e.g., 64 bits wide). In certain examples, carry flag (CF) (e.g., bit) is set (e.g., to binary one) (e.g., by flag logic in an execution circuit that updates the flag register) if the result of an (e.g., arithmetic) operation (e.g., a micro-operation) has an arithmetic carry and cleared (e.g., to binary zero) if there is no arithmetic carry. In certain examples, a zero flag (ZF) is set (e.g., to binary one) (e.g., by flag logic in an execution circuit that updates the flag register) if the result of an (e.g., arithmetic) operation (e.g., a micro-operation) is a zero and cleared (e.g., to binary zero) if not a zero. In certain examples, an adjust flag (AF) (or auxiliary flag or auxiliary carry flag) is set (e.g., to binary one) (e.g., by flag logic in an execution circuit that updates the flag register) if the (e.g., arithmetic) operation (e.g., a micro-operation) has caused an arithmetic carry or borrow (e.g., out of the four least significant bits) and cleared (e.g., to binary zero) otherwise. In certain examples, a parity flag (PG) is set (e.g., to binary one) (e.g., by flag logic in an execution circuit that updates the flag register) if the result of an (e.g., arithmetic) operation (e.g., a micro-operation) has an even number and cleared (e.g., to binary zero) if an odd number. In certain examples, an overflow flag (OF) is set (e.g., to binary one) (e.g., by flag logic in an execution circuit that updates the flag register) if the result of an (e.g., arithmetic) operation (e.g., a micro-operation) overflows and cleared (e.g., to binary zero) if there is no overflow, for example, an overflow when the (e.g., signed two's-complement) result of the operation would not fit in the number of bits used for the operation, e.g., is wider than the execution circuit (e.g., arithmetic logic unit (ALU) thereof) width. In certain examples, a sign flag (SF) is set (e.g., to binary onc) (e.g., by flag logic in an execution circuit that updates the flag register) if the result of an (e.g., arithmetic) operation (e.g., a micro-operation) has a negative number and cleared (e.g., to binary zero) if a positive number, e.g., for a signed (+ or −) value resultant.

In certain examples, the target instruction (e.g., where to “jump” to) is specified with a relative offset (e.g., a signed offset relative to the current value of the instruction pointer in the IP register). In certain examples, a relative offset (rel8, rel16, or rel32) is generally specified as a label in assembly code, but at the machine code level, it is encoded as a signed, 8-bit or 32-bit immediate value, which is added to the instruction pointer. In certain examples, instruction coding is most efficient for offsets of −128 to +127. In certain examples, if the operand-size attribute is 16, the upper two bytes of the EIP register are cleared, resulting in a maximum instruction pointer size of 16 bits.

In certain examples, the Jcc_MH² instruction includes a first operand that indicates the target instruction (e.g., as an offset from the current instruction pointer) and a second operand (e.g., a register, a memory location, or an immediate) that indicates the misprediction handling field (e.g., hint).

As discussed herein, branch misprediction without use of a misprediction handling field (e.g., hint) causes the cancellation of (e.g., one hundred or more) speculatively processed (e.g., “executed”) instructions starting from the mispredicted path (e.g., and may include subsequent instructions that are not subject to speculation, e.g., code after ENDIF). In certain examples, this redirection of processing (e.g., execution) has a large impact in processor performance. Examples herein are directed to a conditional branch with a misprediction handling field (e.g., hint) that addresses this problem for a class of such mispredicted branches. An example class of such instructions are conditional branches that are included (e.g., by the programmer and/or by the compiler) purely for the purpose of avoiding executing of functionally harmless (e.g., “useless”) computation (e.g., when the condition evaluates to false), with a hope of saving computational latency, bandwidth, and power). In the presence of branch misprediction penalty, effectiveness of such an optimization can be reduced or lost, and in some cases, the net effect (of gains, overhead, and penalties) can become a loss. Examples herein allow for such conditional branches to use a misprediction handling field (e.g., hint) to control the cancelation or not of a misprediction.

The following discussed certain examples where such conditional branches that use a misprediction handling field (e.g., hint) to control the cancelation or not of a misprediction may be used are discussed, although it should be understood that other uses are possible. Certain examples where such conditional branches appear are in the vectorization of the code under an IF condition. In certain examples of vectorized code, a mask is used and tested to see if the mask is not all false (e.g., “if (mask !=all false)” guard) but is optional with respect to the functionality of the code, since the masked vectorized code is still functionally correct when mask is all false if executed without the guard. In certain examples, there is a “mask-all-zero bypass” optimization, but a compare/branch cost and misprediction penalty are also introduced. In certain examples, the condition depends on the number of bits in the mask, e.g., branch outcome is data dependent as well as vector length dependent. Theoretically speaking, the likelihood of mask being all false goes down with longer vector.

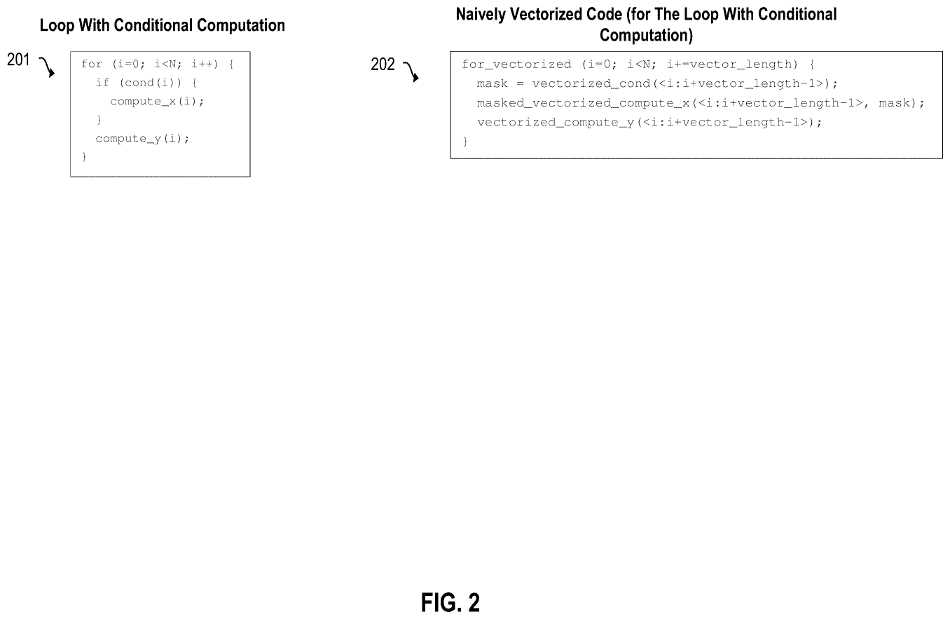

FIG. 2 illustrates first code 201 that includes a loop with a conditional computation (“cond”) and second code 202 that is a (e.g., naively) vectorized version of the first code according to examples of the disclosure. In first code 201, the compute_x occurs only if the condition (“cond”) evaluates to true (and then proceed to compute_y), and if the condition is false, execution jumps to compute_y. In second code 202, a vector mask (“mask”) is computed from the vectorized condition check (“vectorized_cond”). The vectorized compute_x (“masked_vectorized_compute_x”) is executed for all elements of the vector, but the meaningful computation happens only for those element(s) where the condition (“cond”) evaluates to true (which is signified by the corresponding part of the vector mask). The vectorized compute_y (“vectorized_compute_y”) is then executed for all elements of the vector.

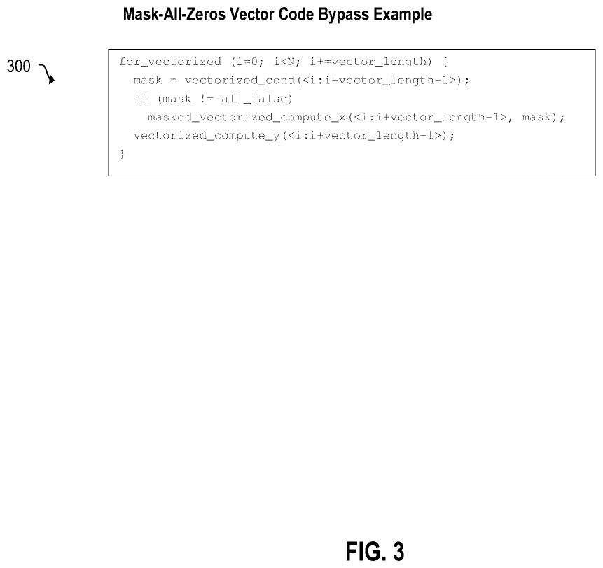

FIG. 3 illustrates code 300 that includes vectorized code that includes a mask-all-zeros bypass according to examples of the disclosure. If the condition (e.g., cond( ) check (e.g., frequently) evaluates to false, in certain examples it is beneficial (e.g., reduces execution time of the whole loop) to insert a conditional branch (e.g., Jcc instruction) that checks whether the mask value is not “all false” (e.g., not all-zeros) before executing masked_vectorized_compute_x( ). In certain examples, the compiler/programmer knows that masked_vectorized_compute_x( ) can be safely executed regardless of the value of the mask. In certain examples, this conditional branch includes a misprediction handling field (e.g., hint) to control the cancelation or not of a misprediction.

If the conditional branch (“IF” here) is (mis)predicted towards THEN (e.g., masked_vectorized_compute_x( )) and speculative execution reaches vectorized_compute_y( ) prior to the actual resolution towards ELSE of the branch is known to the hardware, it can cost more time and power to cancel the already started masked_vectorized_compute_x( ) and vectorized_compute_y( ) and restart fetching vectorized_compute_y( ) from scratch rather than letting the misspeculated masked_vectorized_compute_x( ) and vectorized_compute_y( ) complete as if misprediction was not detected. Certain examples herein thus utilize a conditional branch instruction that uses a misprediction handling field (e.g., hint) to control the cancelation or not of a misprediction.

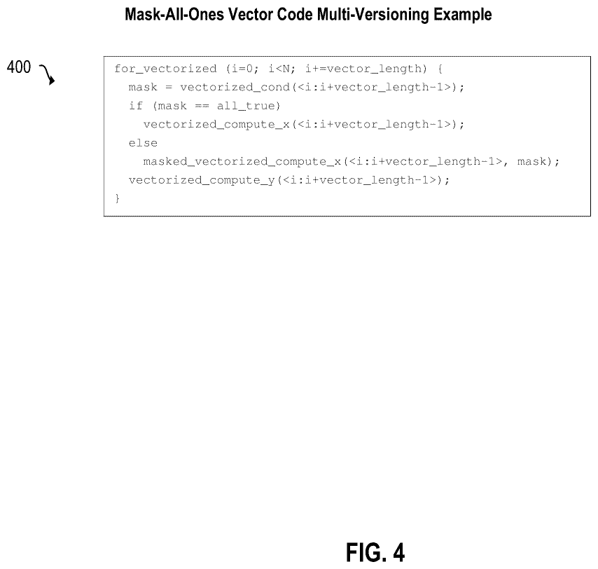

FIG. 4 illustrates code 400 that includes vectorized code that includes mask-all-ones multi-versioning according to examples of the disclosure. If the condition (e.g., cond( ) check (e.g., frequently) evaluates to true, in certain examples it is beneficial (e.g., reduces execution time of the whole loop) to multi-version the code by checking whether the mask value is “all true” (e.g., all-ones) in order to choose between more performant vectorized_compute_x( ) and less performant masked_vectorized_compute_x( )) In certain examples, when the compiler or the programmer inserts this kind of conditional branch, as a purely time saving optimization, it is understood that the ELSE part of the conditional branch (e.g., masked_vectorized_compute_x( ) has the same net effect as vectorized_compute_x( ) when the mask is all true. In certain examples, this conditional branch includes a misprediction handling field (e.g., hint) to control the cancelation or not of a misprediction.

If the conditional branch (“IF” here) is (mis)predicted towards ELSE (e.g., masked_vectorized_compute_x( )) and speculative execution goes s through most of masked_vectorized_compute_x( ) prior to the actual resolution towards THEN of the branch is known to the hardware, it can cost more time and power to cancel already started masked_vectorized_compute_x( )(and possibly vectorized_compute_y( ) and restart fetching vectorized_compute_x( ) from scratch rather than letting misspeculated masked_vectorized_compute_x( )(and vectorized_compute_y( ) complete as if misprediction was not detected. Certain examples herein thus utilize a conditional branch instruction that uses a misprediction handling field (e.g., hint) to control the cancelation or not of a misprediction.

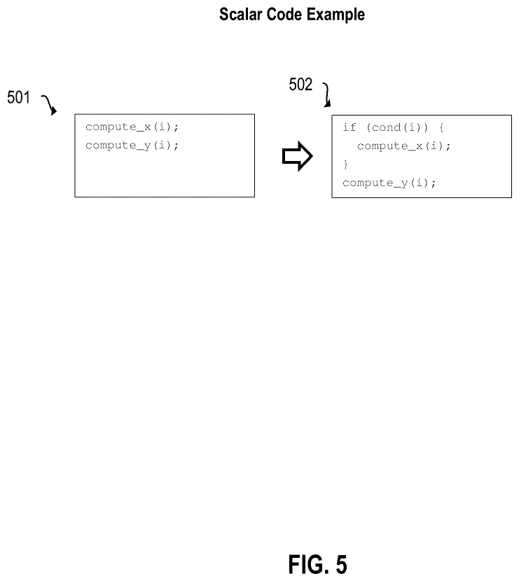

FIG. 5 illustrates first scalar code 501 and second code 502 that includes a conditional computation (e.g., IF) version of the first code according to examples of the disclosure. In certain examples, programmers sometimes insert a conditional branch as in second code 502 when the aggregate effect of compute_x( ) is known to be a no-operation (no-op) if cond( ) evaluates to false, in order to reduce the total execution time. Similar to FIG. 3, if mispredicted towards THEN (e.g., compute_x( ) and move on to compute_y( )), it can cost more time and power to cancel already started compute_x( ) and compute_y( ) and restart compute_y( ) from scratch. Certain examples herein thus utilize a conditional branch instruction that uses a misprediction handling field (e.g., hint) to control the cancelation or not of a misprediction.

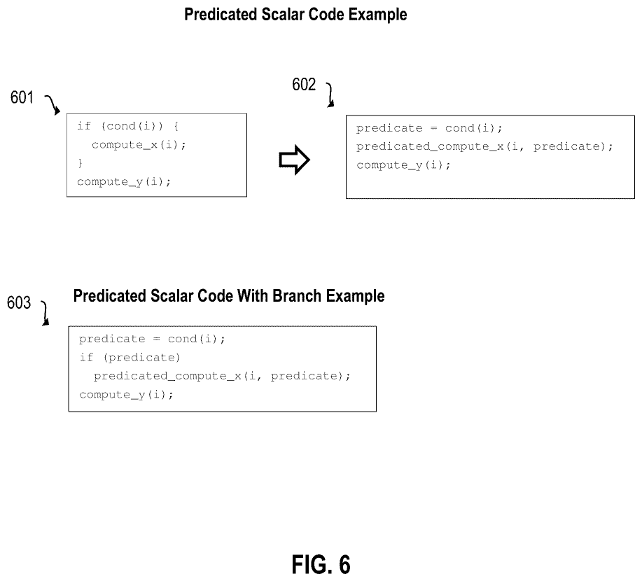

FIG. 6 illustrates first scalar code 601, second code 602 that includes a predicated version of the first code 601, and a third code 603 that includes a conditional computation version of the code 602 according to examples of the disclosure. Some architectures support predicated scalar instructions that can be used to trade off control dependence (e.g., branch) and data dependence. The predication optimization herein may be applied in order to avoid suffering from high branch misprediction penalties of hard-to-predict branches. It may appear counterintuitive to insert a branch back to such a predicated scalar code 602 as in code 603, but the use of a conditional branch that includes a misprediction handling field (e.g., hint) to control the cancelation or not of a misprediction allows the lowering of misprediction penalty. In certain examples, this counterintuitive code 603 performs better than both the plain predicated scalar code 602 and the original scalar code 601. Because of the predication applied to predicated_compute_x( ) in code 602, the safety determination for using a conditional branch that includes a misprediction handling field (e.g., hint) (e.g., Jcc_MH²) becomes easier than the (non-predicated) compute_x( ) in scalar code 601. In certain examples, for scalar code 601, the compute_x( ) is analyzed to determine whether unconditionally executing compute_x( ) is safe and also whether the net effect of compute_x when cond( ) is false is a no-op (and thus Jcc_MH² instruction may be used).

In certain examples, mispredicting into the generic_code( ) is okay to continue instead of cancelling it and then restarting with the correct (e.g., specialized) code. For example, according to the following pseudocode:

if (can_use_special_case){ special_case_code( ); }
else { generic_code( ); }.

Certain examples herein thus utilize a conditional branch instruction that uses a misprediction handling field (e.g., hint) to control the cancelation or not of a misprediction.

If the cost of cancelling the speculative execution of such functionally-harmless instructions (and any subsequent instructions) is more expensive than letting them finish executing, in certain examples it is more advantageous to let them finish (e.g., finish executing and retire them). In certain examples, this is accomplished by introducing a new class of conditional branch that includes a misprediction handling field (e.g., hint) to control the cancelation or not of a misprediction, e.g., called a Jcc with Misprediction Handling Hint (Jcc_MH²) instruction. In certain examples, the conditional branch instruction provides its misprediction handling field (e.g., hint) to the hardware on the handling of wrong path execution in the event of a branch misprediction. In certain examples, the conditional branch that includes a misprediction handling field (e.g., hint) (e.g., Jcc_MH²) instruction reduces the penalty when a branch predictor mispredicts a conditional branch that is placed for avoiding to execute “functionally harmless” instructions and the hardware starts speculatively executing “functionally harmless” code path, by not cancelling them (and thus letting them retire), e.g., and not also causing the fetch of the correct path. In certain examples, the improvements come from keeping subsequent speculatively executed “useful instructions” inflight instead of getting them cancelled as a side effect of cancelling “functionally harmless” code. In certain examples, due to the increasing out-of-order pipeline capacity and widening gap between compute speed and memory speed (e.g., where Jcc depends on a load), branch misprediction penalties are worsening, and thus the conditional branch that includes a misprediction handling field (e.g., hint) (e.g., Jcc_MH²) instruction provides a mitigation to that problem.

In certain examples, the misprediction handling field is to store a value that indicates one or more of: (i) cancel (e.g., misprediction in either direction requires cancellation, (ii) OptionalCancelForTaken (e.g., cancellation is optional if mispredicted towards taken but real outcome is not-taken; misprediction towards not-taken requires cancellation when real outcome is taken) and/or (iii) OptionalCancelForNotTaken (e.g., cancellation is optional if mispredicted towards not-taken but real outcome is taken; misprediction towards taken requires cancellation when real outcome is not-taken).

Thus, in certain examples, the behavior of Jcc_MH² with cancel hint is the same as a conditional branch (e.g., Jcc) without a hint. In certain examples, the use of the hint is optional for a conditional instruction. Potential usage by some examples includes post-binary optimization (e.g., changing from one hint to another) without changing the size of the instruction (e.g., a desirable property to have for binary patching). Certain examples herein are useful for extending an existing Jcc instruction to add Jcc_MH² feature, e.g., for providing backward compatibility.

In certain examples, ensuring the safety of using the two other hints (ii)-(iii) is (e.g., mainly) a compiler's or (e.g., assembly language (ASM)) programmer's responsibility. In certain examples, an instruction can support either or both of OptionalCancelForTaken and OptionalCancelForNotTaken hints.

In certain examples, when “taken misprediction” is detected for a Jcc_MH² instruction with OptionalCancelForTaken hint, hardware is to let the instruction retire without re-steering, e.g., keeping all inflight instructions (e.g., those instructions that are the Jcc_MH² taken target instruction and later in program order) continue executing. In certain examples, when a “not-taken misprediction” is detected for a Jcc_MH² instruction with OptionalCancelForNotTaken hint, hardware is to let the instruction retire without re-steering e.g., keeping all inflight instructions (e.g., those instructions that follows the Jcc_MH² instruction in program order) continue executing. In certain examples, hardware (e.g., a core) has the ability to retire at least one such mispredicted Jcc_MH² instruction without re-steering to the resolved (e.g., in a conventional Jcc sense) next instruction (e.g., “NextIP”) of Jcc_MH². Said another way, certain examples herein effectively override the NextIP determination via the hint.

Certain examples herein utilize reserved bits of an existing conditional branch encoding that are currently ignored by hardware in order to represent Jcc_MH² and associated hints. In certain examples, application binary using Jcc_MH² can be made compatible to existing hardware (e.g., instruction set architecture (ISA)) since ignoring the hint and hence following a conventional (e.g., always) “cancel mispredicted instructions” is functionally correct.

In certain examples, a conditional branch that includes a misprediction handling field (e.g., hint) is differentiated from a conditional branch that does not include a misprediction handling field (e.g., hint), for example, by using an instruction prefix/suffix and/or implicit/explicit additional/different operand.

In certain examples, a conditional branch has more than two possible targets (e.g., using a jump table address and the offset into the table). In certain examples, an unconditional jump is used to implement a conditional branch (e.g., loading target address from a jump table using the offset into the table). In certain examples, a misprediction handling field (e.g., hint) is an index value. In certain examples, a misprediction handling field (e.g., hint) is a whole or part of branch/jump target address. In certain examples, a branch instruction supports more than one misprediction handling field (e.g., more than one misprediction handling hint).

In certain examples, when a “taken misprediction” is detected for a Jcc_MH² instruction with OptionalCancelForTaken hint, the hardware (e.g., branch predictor 120 and/or branch prediction manager 110) can let the instruction retire without cancellation (e.g., without re-steering), e.g., allowing all inflight instructions to continue executing.

In certain examples, when a “not-taken misprediction” is detected for a Jcc_MH² instruction with OptionalCancelForNotTaken hint, the hardware (e.g., branch predictor 120 and/or branch prediction manager 110) can let the instruction retire without cancellation (e.g., without re-steering), e.g., allowing all inflight instructions to continue executing.

In certain examples, by letting a small number of “useless but harmless computation” mispredicted instructions retire according to a misprediction handling field (e.g., hint) of a conditional branch, hardware (e.g., a core) can keep executing the subsequent valid instructions versus cancelling all those (e.g., 100 plus) instructions, e.g., where this results in faster execution of the code and/or a reduction in wasted computation that results in reduction of power consumption. In certain examples, gains come from the pull-in of the fetch of the instruction at (fully resolved) NextIP of JCC_MH² (e.g., code after endif), if such an instruction is already speculatively fetched (e.g., that are subject to cancellation under conventional misprediction handling).

In certain examples, branch misprediction penalty may be mitigated by removing the IF (e.g., via predication). However, avoiding IF is not always profitable, since unconditionally computing can be costlier than occasionally hitting a high misprediction penalty. Using a conditional branch that includes a misprediction handling field (e.g., hint) disclosed herein allows for the use of a condition (e.g., IF) to minimize a misprediction penalty.

In certain example, there is a limit in branch predictor improvements for reducing the misprediction ratio (e.g., are not perfect). Using a conditional branch that includes a misprediction handling field (e.g., hint) disclosed herein allows the use of a conditional (e.g., IF) branch, e.g., does not require turning off conditional branch prediction by a branch predictor.

Shortcomings in conventional thinking for salvaging the mispredicted (but useful) instructions from getting cancelled are due to the combination of the following: (i) trying to cancel harmless instructions from the mispredicted path, and (ii) at the same time, try to restart fetching from the correct path. In certain examples, (i) would require the hardware (e.g., branch predictor) to identify and keep track of the instructions that are control dependent on each conditional instruction (e.g., Jcc) of interest. In certain examples, (ii) would require the hardware (e.g., branch predictor) to insert new blocks of code into the out-of-order reorder buffer, ahead of the subsequent useful instructions that are already in-flight, and correctly splice the data dependency across them. However, there are certain uses, e.g., discussed herein, where (i) and (ii) are not required. In those uses, because there is no need to cancel functionally-harmless (e.g., they will not affect the results of any operations) instructions from the mispredicted path, the processor allows them to finish executing/retiring (e.g., as indicated to the hardware by the hint). In certain examples, safety and semantical equivalence is asserted by the software.

In certain examples, there are no instructions that need to be newly fetched from the “correct” path where the hardware (e.g., branch predictor) is allowed to continue executing along the mispredicted path, e.g., a detected misprediction is treated as if the misprediction was never detected (e.g., under control of the hint). This leads to great simplifications towards the hardware implementation, e.g., hardware is to differentiate Jcc_MH² from a plain Jcc and/or determine which direction of the branch is safe to continue in the event of misprediction. In certain examples, the hint indicates “Mispredict to Taken” prediction is safe to continue when the correct direction is NotTaken and/or “Mispredict to NotTaken” prediction is safe to continue when the correct direction is Taken. In certain examples, this can be accomplished by any means to differentiate one instruction (or instruction behavior) from another, for example, using different opcodes, applying an instruction prefix, utilizing a reserved bit within Jcc instruction if one is available, using an immediate operand, etc. For certain (e.g., x86) architectures, one example approach is to use (e.g., two of) the reserved (e.g., segment override) prefixes, e.g., following the precedence of 0x2E/0x3E BranchHint prefixes. It has a code size impact, but will not consume the available opcode space. In certain examples, behavior of Jcc_MH² is differs from Jcc only when misprediction occurs.

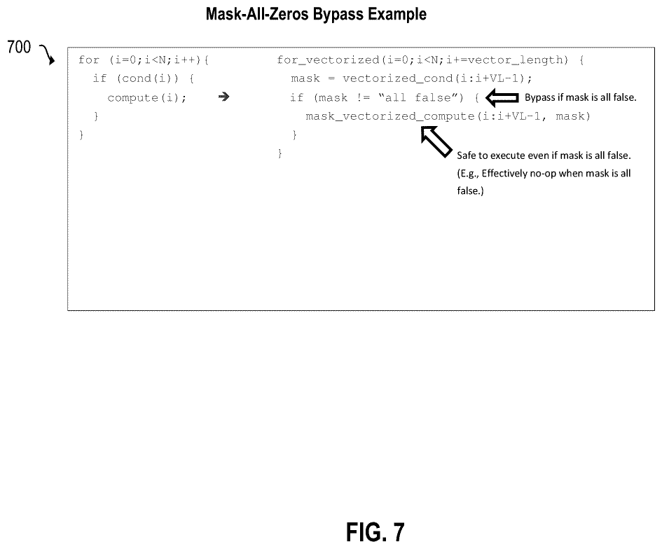

FIG. 7 illustrates code that includes vectorized code 700 that includes a mask-all-zeros bypass that is safe to execute even if the mask is all false according to examples of the disclosure. In particular, code 700 is a simplified version of a Mask-All-Zeros Bypass example in FIG. 3.

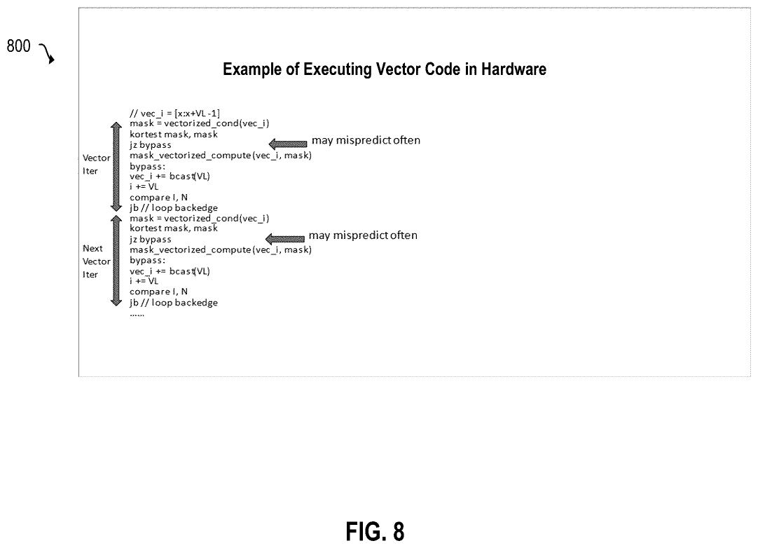

FIG. 8 illustrates a speculative execution of vectorized code 700 that includes vector iterations that include a conditional instruction (e.g., a conditional jump instruction with the mnemonic of JZ) according to examples of the disclosure. In certain examples, the JZ instruction is to jump to the target instruction when the zero flag (ZF) is set to one, i.e., indicating the condition evaluated to zero (e.g., a comparison or arithmetic operation may be performed before the JZ instruction). In one example, the two instances of JZ in FIG. 8 are predicted as NotTaken, e.g., the execution goes to the next instruction in program order (“mask_vectorized_compute( )”).

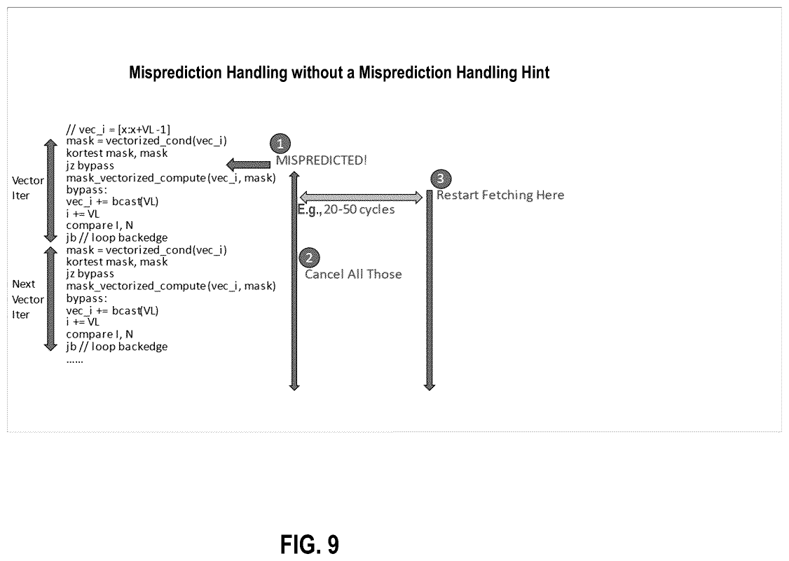

FIG. 9 illustrates handling of a misprediction of a conditional instruction of the code in FIG. 7 without utilizing a field (e.g., a misprediction handling hint) of an instruction (e.g., conditional jump instruction “JZ”) according to examples of the disclosure. In FIG. 9, the first instance of the JZ bypass is found to be mispredicted (circled 1 in FIG. 9), so the conventional Jcc misprediction handling is to cancel all subsequent instructions (indicated by the circled 2 in FIG. 9), and restart from fetching the instruction at the correct branch target (circled 3 in FIG. 9).

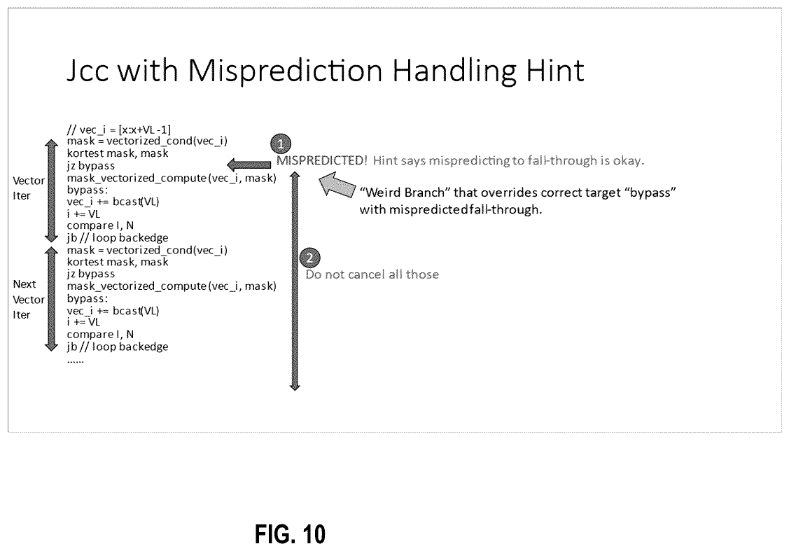

FIG. 10 illustrates handling of a misprediction of a conditional instruction of the code in FIG. 7 by utilizing a field (e.g., a misprediction handling hint) of an instruction according to examples of the disclosure. More particularly, FIG. 10 illustrates how the misprediction in FIG. 9 is handled when the conditional branch instruction includes a misprediction handling field (e.g., hint) to control the cancelation or not of a misprediction. In FIG. 10, the first instance of the JZ bypass is found to be mispredicted (circled 1 in FIG. 10), so with a Jcc_MH² having a “NotTaken is safe to continue when the correct direction is Taken” hint, the hardware (e.g., core) is to continue processing without cancelling the subsequent instructions (indicated by the circled 2 in FIG. 10). Comparing the not-cancelled, but mispredicted, code at circled 2 in FIG. 10 to the cancelled because it was mispredicted code at circled 2 in FIG. 9, illustrated a pull-in of the start of vec_i+=bcast (VL) instruction processing. Depending on how quickly the branch outcome is finalized and the size of the “functionally-harmless” mask_vectorized_compute( ) that continues executing, the benefit of Jcc_MH² can be significant (for example, 20-50 cycles or more, e.g., if the branch outcome is dependent on data coming in from system memory).

In certain examples, the benefit (e.g., time and power savings) of Jcc_MH² for cach such misprediction occurrences depends on the cost differences between the more performant code path and the less performant code path and how quickly the branch outcome is resolved. In certain examples, the hardware (e.g., branch predictor) is to monitor the performance of the hint, e.g., and decide whether to follow the hint or not, e.g., such that in certain examples, the instruction is not a “Misprediction Handling Directive”, but a hint, such that certain examples ignore the hint.

FIG. 11 illustrates examples of computing hardware to process a branch instruction with a misprediction handling hint, such as a Jcc_MH² instruction. As illustrated, storage 1103 stores an “(e.g., conditional) instruction with a misprediction handling hint” instruction 1101 to be executed.

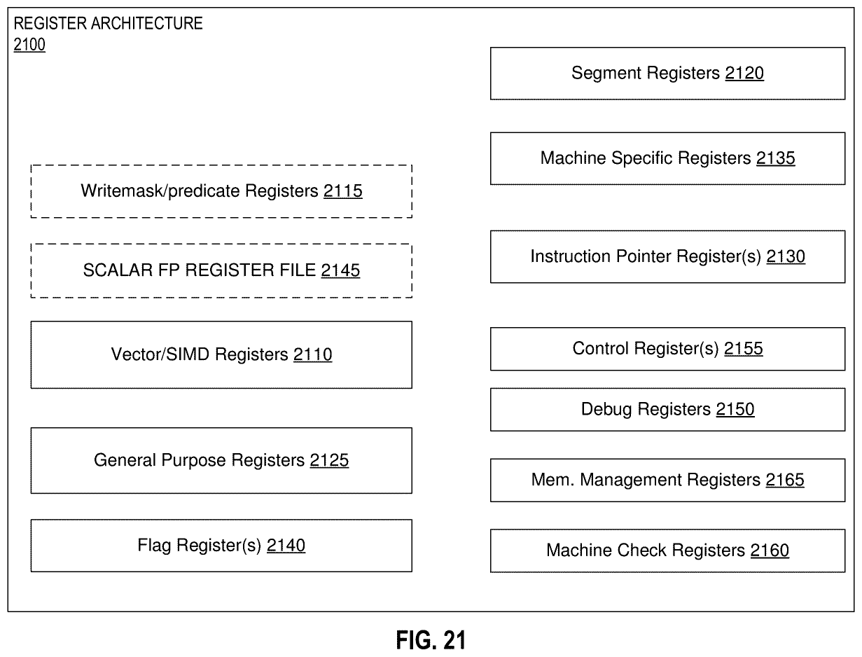

The instruction 1101 is received by decoder circuitry 1105. For example, the decoder circuitry 1105 receives this instruction from fetch circuitry (not shown). The instruction may be in any suitable format, such as that describe with reference to FIG. 22 below. In an example, the instruction includes fields for an opcode, a target instruction, and a misprediction handling field (e.g., hint). In some examples, the sources and destination are registers, and in other examples one or more are memory locations. In some examples, one or more of the sources may be an immediate operand. In certain examples, the opcode details the control over causing a processor (e.g., the branch predictor 1112) to disallow (or allow) cancelling of the processing of the instructions (e.g., allows retirement of those instructions) on a mispredicted path of a (e.g., conditional) branch according to the misprediction handling hint to be performed.

More detailed examples of at least one instruction format for the instruction will be detailed later. The decoder circuitry 1105 decodes the instruction into one or more operations. In some examples, this decoding includes generating a plurality of micro-operations to be performed by execution circuitry (such as execution circuitry 1109). The decoder circuitry 1105 also decodes instruction prefixes.

In some examples, register renaming, register allocation, and/or scheduling circuitry 1107 provides functionality for one or more of: 1) renaming logical operand values to physical operand values (e.g., a register alias table in some examples), 2) allocating status bits and flags to the decoded instruction, and 3) scheduling the decoded instruction for execution by execution circuitry out of an instruction pool (e.g., using a reservation station in some examples).

Registers (register file) and/or memory 1108 store data as operands of the instruction to be operated by execution circuitry 1109. Example register types include packed data registers, general purpose registers (GPRs), and floating-point registers.

Execution circuitry 1109 executes the decoded instruction. Example detailed execution circuitry includes execution circuit 154 shown in FIG. 1, and execution cluster(s) 1960 shown in FIG. 19B, etc. In certain examples, the execution of the decoded instruction causes the execution circuitry to cause a processor (e.g., the branch predictor 1112) to disallow (or allow) cancelling of the processing of the instructions (e.g., allows retirement of those instructions) on a mispredicted path of a (e.g., conditional) branch.

In some examples, retirement (e.g., write back) circuitry 1111 architecturally commits the destination register into the registers or memory 1108 and retires the instruction.

An example of a format for an (e.g., conditional) instruction with a misprediction handling hint is OPCODE DST, SRC. In some examples, OPCODE is the opcode mnemonic of the instruction. DST is a field for the destination operand (e.g., jump target), such as a register or memory. SRC is a field for the source operand (e.g., hint), such as an immediate, packed data register, and/or memory.

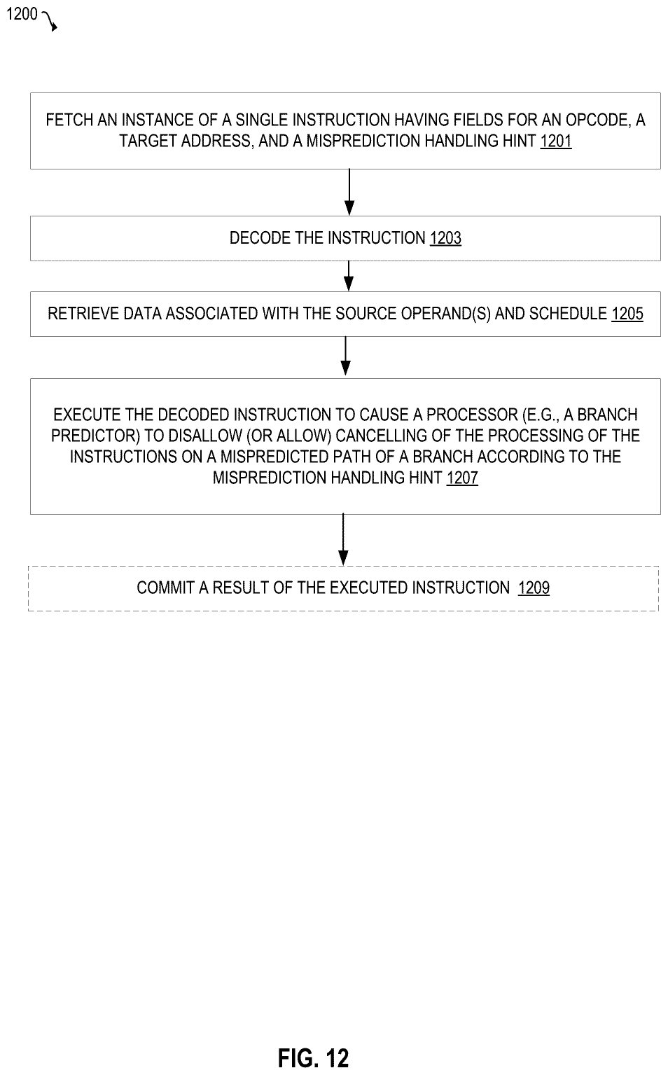

FIG. 12 illustrates an example method performed by a processor to process a (e.g., conditional) branch instruction with a misprediction handling hint. For example, a processor core as shown in FIG. 19B, a pipeline as detailed below, etc., performs this method.

At 1201, an instance of single instruction is fetched. For example, a (e.g., conditional) branch instruction with a misprediction handling hint is fetched. The instruction includes fields for an opcode, jump target (e.g., address or offset), and hint (e.g., OptionalCancelForTaken hint and/or OptionalCancelForNotTaken hint). In some examples, the instruction further includes a field for a writemask. In some examples, the instruction is fetched from an instruction cache. In certain examples, the opcode indicates a processor (e.g., the branch predictor 1112) is to disallow (or allow) cancelling of the processing of the instructions (e.g., allowing retirement of those instructions) on a mispredicted path of a (e.g., conditional) branch according to the misprediction handling hint.

The fetched instruction is decoded at 1203. For example, the fetched (e.g., conditional) instruction with a misprediction handling hint instruction is decoded by decoder circuitry such as decoder circuitry 1105 or decode circuitry 1940 detailed herein.

Data values associated with the source operands of the decoded instruction are retrieved when the decoded instruction is scheduled at 1205. For example, when one or more of the source operands are memory operands, the data from the indicated memory location is retrieved.

At 1207, the decoded instruction is executed by execution circuitry (hardware) such as execution circuit 154 shown in FIG. 1, execution circuitry 1109 shown in FIG. 11, or execution cluster(s) 1960 shown in FIG. 19B. For the (e.g., conditional) instruction with a misprediction handling hint instruction, the execution will cause execution circuitry to perform the operations described in connection with FIG. 1. In various examples, the operations are according to the disclosure herein.

In some examples, the instruction is committed or retired at 1209.

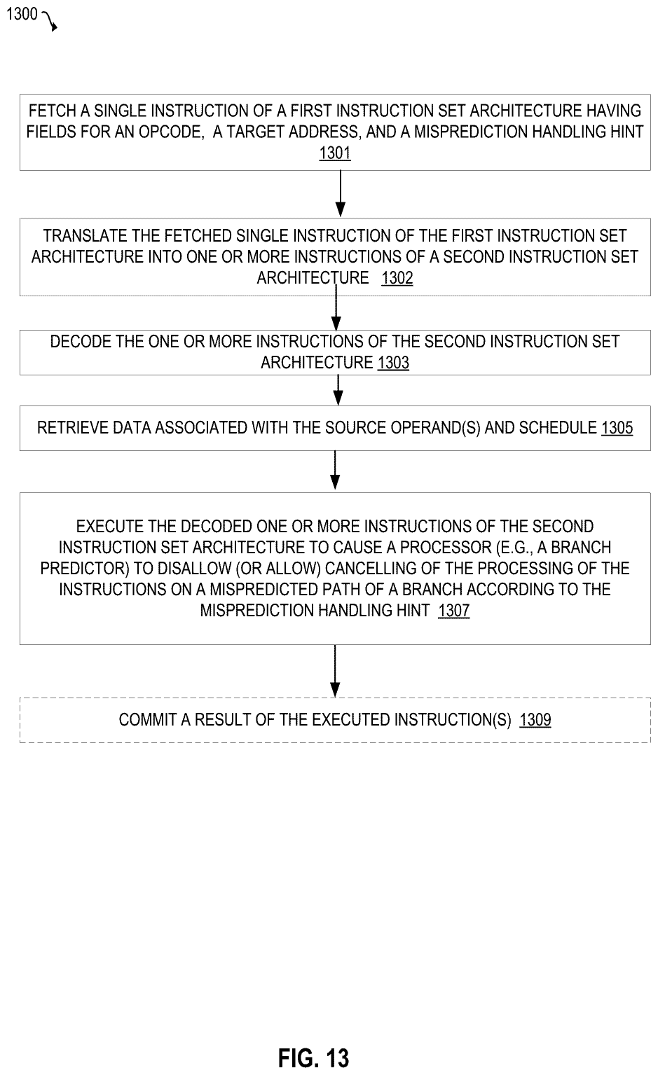

FIG. 13 illustrates an example method to process an (e.g., conditional) instruction with a misprediction handling hint using emulation or binary translation. For example, a processor core as shown in FIG. 19B, a pipeline and/or emulation/translation layer perform aspects of this method.

An instance of a single instruction of a first instruction set architecture is fetched at 1301. The instance of the single instruction of the first instruction set architecture includes fields for an opcode, jump target (e.g., address or offset), and hint (e.g., OptionalCancelForTaken hint and/or OptionalCancelForNotTaken hint). In some examples, the instruction further includes a field for a writemask. In some examples, the instruction is fetched from an instruction cache. In certain examples, the opcode indicates a processor (e.g., the branch predictor 1112) is to disallow (or allow) cancelling of the processing of the instructions (e.g., allows retirement of those instructions) on a mispredicted path of a (e.g., conditional) branch.

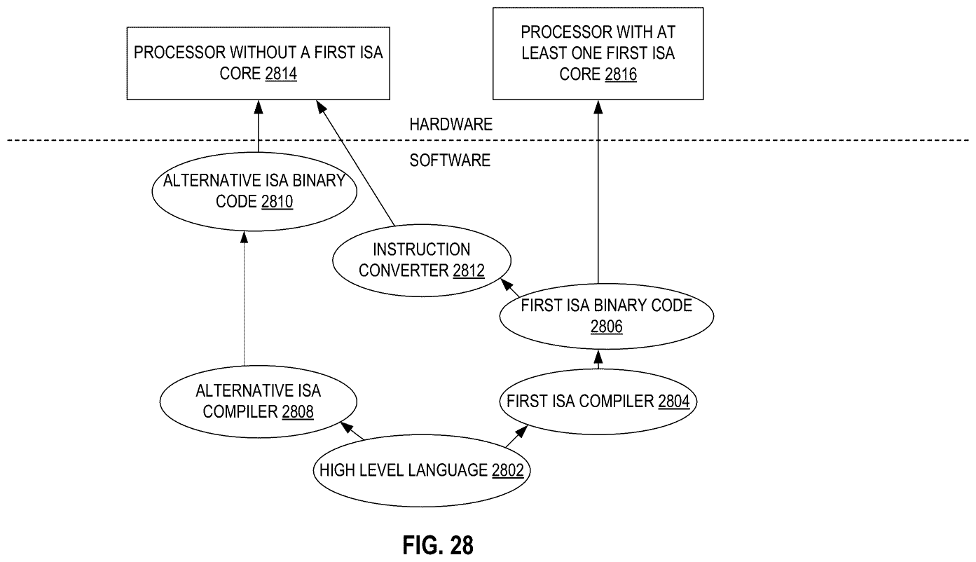

The fetched single instruction of the first instruction set architecture is translated into one or more instructions of a second instruction set architecture at 1302. This translation is performed by a translation and/or emulation layer of software in some examples. In some examples, this translation is performed by an instruction converter 2812 as shown in FIG. 28. In some examples, the translation is performed by hardware translation circuitry.

The one or more translated instructions of the second instruction set architecture are decoded at 1303. For example, the translated instructions are decoded by decoder circuitry such as decoder circuitry 1105 or decode circuitry 1940 detailed herein. In some examples, the operations of translation and decoding at 1302 and 1303 are merged.

Data values associated with the source operand(s) of the decoded one or more instructions of the second instruction set architecture are retrieved and the one or more instructions are scheduled at 1305. For example, when one or more of the source operands are memory operands, the data from the indicated memory location is retrieved.

At 1307, the decoded instruction(s) of the second instruction set architecture is/are executed by execution circuitry (hardware) such as execution circuit 154 shown in FIG. 1, execution circuitry 1109 shown in FIG. 11, or execution cluster(s) 1960 shown in FIG. 19B, to perform the operation(s) indicated by the opcode of the single instruction of the first instruction set architecture. For the (e.g., conditional) instruction with a misprediction handling hint instruction, the execution will cause execution circuitry to perform the operations described in connection with FIG. 1. In various examples, the operations cause a processor (e.g., a branch predictor) to disallow (or allow) cancelling of the processing of the instructions (e.g., allows retirement of those instructions) on a mispredicted path of a (e.g., conditional) branch according to the misprediction handling hint.

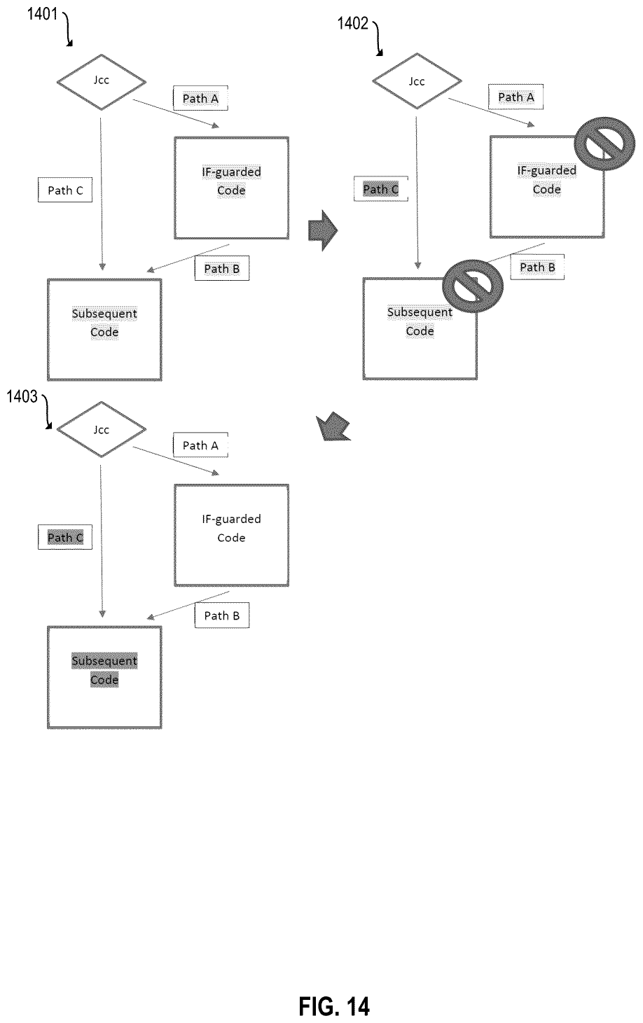

FIG. 14 illustrates handling of a misprediction of a conditional instruction without utilizing a field (e.g., a misprediction handling hint) of the conditional instruction for a code section having a path A to “IF” guarded code from the conditional instruction, a path B to subsequent code from the “IF” guarded code, and a path C to the subsequent code from the conditional instruction. In certain examples, (e.g., at prediction time 1401 but before the branch condition is actually resolved), a branch predictor (e.g., circuit) predicts the conditional instruction is to take Path A (e.g., indicated by yellow) and starts speculatively processing (e.g., executing) IF-guarded Code and proceeds to Path B and Subsequent Code, but if the processor (e.g., Jcc instruction executing on the processor) later determines that Path C is the correct control flow (e.g., indicated by green) to follow, IF-Guarded Code and Subsequent Code from the mispredicted path are cancelled at time 1402 and then the Subsequent Code is processed (e.g., fetched, decoded, and executed) again along Path C at time 1403. However, this misprediction handling wastes all the processing of Subsequent Code that occurred before such a cancellation. Examples herein are directed to a conditional instruction with a misprediction handling hint that causes a processor (e.g., a branch predictor) to disallow (or allow) cancelling of the processing of the instructions (e.g., allows retirement of those instructions) on a mispredicted path of a conditional branch according to the misprediction handling hint, e.g., to save the processing that occurred before it was determined that the predicted path was a misprediction.

Although the above is shown with “IF-guarded” code, it should be understood that other types of code (e.g., instructions) may (e.g., instead) be included.

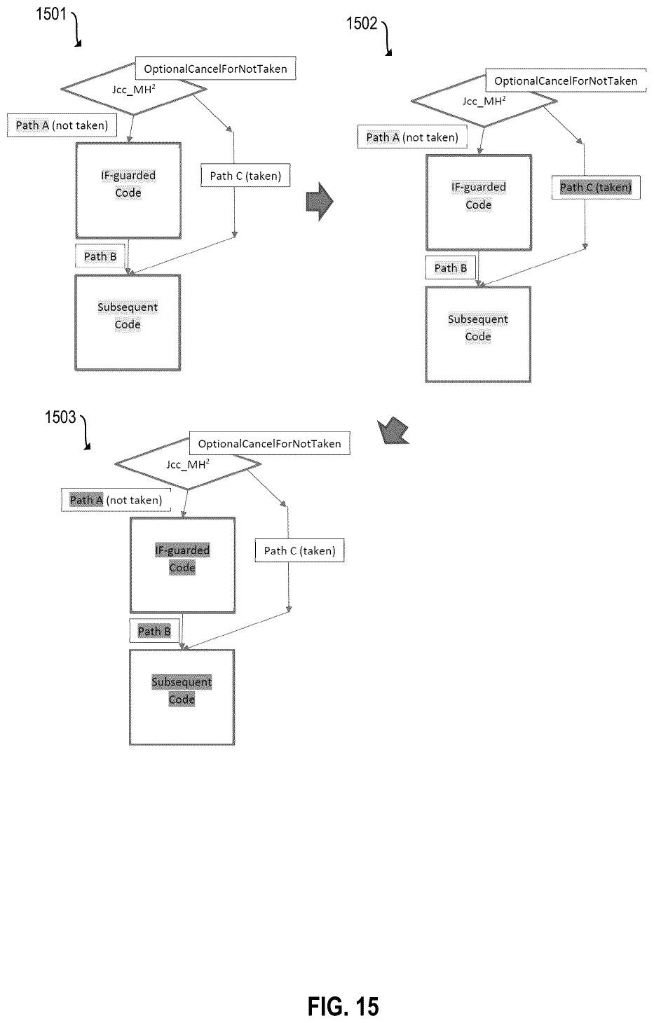

FIG. 15 illustrates handling of a misprediction of a conditional instruction (e.g., “JCC_MH²”) by utilizing a “optional cancel for not-taken” (e.g., cancellation_is_optional_if_mispredicted_towards_not-taken) field (e.g., a misprediction handling hint) of the conditional instruction for a code section having a path A to “IF” guarded code from the conditional instruction, a path B to subsequent code from the “IF” guarded code, and a path C to the subsequent code from the conditional instruction, e.g., with path A being referred to as the “not-taken” path (e.g., the “fall-through” path followed when the conditional instruction Jcc_MH² evaluates to “false”) and with path C being referred to as the taken path (e.g., the jump taken when the conditional instruction Jcc_MH² evaluates to “true”). In certain examples, when the conditional instruction (e.g., Jcc_MH²) is predicted as “not taken” by a branch predictor, similar to the Jcc case discussed above in FIG. 14, IF-guarded Code and Subsequent Code are speculatively executed along Path A and Path B. In certain examples, (e.g., at prediction time 1501 but before the branch condition is actually resolved), a branch predictor (e.g., circuit) predicts the conditional instruction is to take Path A (e.g., indicated by yellow) and starts speculatively processing (e.g., executing) IF-guarded Code and proceeds to Path B and Subsequent Code, but even though the processor (e.g., Jcc_MH² instruction executing on the processor) later at time 1502 determines that Path C is the correct control flow (e.g., indicated by green) to follow, the hint allows the processor to continue at time 1503 processing (e.g., executing) IF-guarded Code and Subsequent Code based on the attached hint. Thus, certain examples of a Jcc_MH² instruction enable a processor to continue processing instructions on a mispredicted path (e.g., through retirement and to allow the results of those instruction on the mispredicted path to become architecturally visible). In certain examples, the hardware (e.g., branch predictor) effectively ignores that Jcc_MH² was mispredicted for the purpose of instruction retirement based on the hint. In certain examples, for the purpose of the branch predictor state update, such fact of misprediction can be included but does not have to be included. Either approach can be utilized in certain examples. In certain examples, if Jcc_MH² is mispredicted as “taken” (e.g., path C) by a branch predictor in the above examples, the instructions along the mispredicted path are cancelled, e.g., based on the Jcc_MH² not having an OptionalCancelForTaken hint.

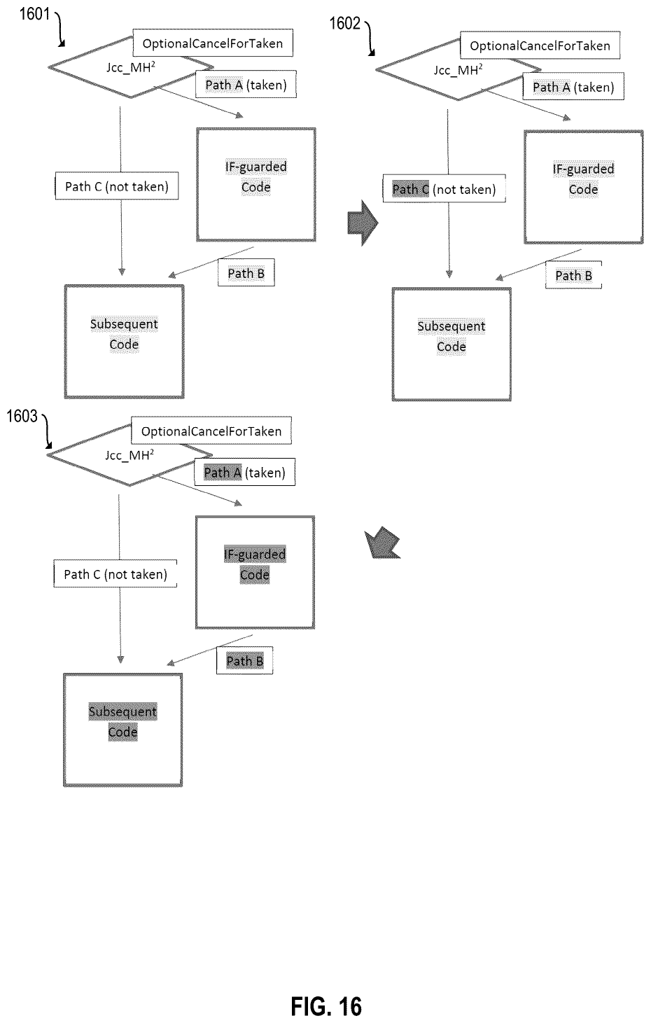

FIG. 16 illustrates handling of a misprediction of a conditional instruction (e.g., “JCC_MH²”) by utilizing a “optional cancel for taken” (e.g.,

cancellation_is_optional_if_mispredicted_towards_taken) field (e.g., a misprediction handling hint) of the conditional instruction for a code section having a path A to “IF” guarded code from the conditional instruction, a path B to subsequent code from the “IF” guarded code, and a path C to the subsequent code from the conditional instruction, e.g., with path C being referred to as the “not-taken” path (e.g., the “fall-through” path followed when the conditional instruction Jcc_MH² evaluates to “false”) and with path A being referred to as the taken path (e.g., the jump taken when the conditional instruction Jcc_MH² evaluates to “true”). In certain examples, when the conditional instruction (e.g., Jcc_MH²) is predicted as “taken” by a branch predictor, IF-guarded Code and Subsequent Code are speculatively executed along Path A and Path B. In certain examples, (e.g., at prediction time 1601 but before the branch condition is actually resolved), a branch predictor (e.g., circuit) predicts the conditional instruction is to take Path A (e.g., indicated by yellow) and starts speculatively processing (e.g., executing) IF-guarded Code and proceeds to Path B and Subsequent Code, but even though the processor (e.g., Jcc_MH² instruction executing on the processor) later at time 1602 determines that Path C is the correct control flow (e.g., indicated by green) to follow, the hint allows the processor to continue at time 1603 processing (e.g., executing) IF-guarded Code and Subsequent Code based on the attached hint. Thus, certain examples of a Jcc_MH² instruction enable a processor to continue processing instructions on a mispredicted path (e.g., through retirement and to allow the results of those instruction on the mispredicted path to become architecturally visible). In certain examples, the hardware (e.g., branch predictor) effectively ignores that Jcc_MH² was mispredicted for the purpose of instruction retirement based on the hint. In certain examples, for the purpose of the branch predictor state update, such fact of misprediction can be included but does not have to be included. Either approach can be utilized in certain examples. In certain examples, if Jcc_MH² is mispredicted as “not-taken” (e.g., path C) by a branch predictor in the above examples, the instructions along the mispredicted path are cancelled, e.g., based on the Jcc_MH² not having an OptionalCancelForNotTaken hint.

In certain examples, the cost modeling to include an instruction with a hint (and/or to follow the hint) is performed. Such cost modeling considerations can be hardware based cost modeling, software and hardware based cost modeling, or software based cost modeling.

Certain examples choose to apply hardware-based analysis (e.g., by a performance monitoring unit of the processor) and/or cost modeling to finalize the determination of skipping the cancellation (e.g., Jcc_MH²) or cancel as a conditional instruction without a hint would do. In certain examples, the hardware (e.g., processor) has better visibility in the current state of the branch misprediction rate, statistical data about potential gains for each misprediction, and/or “size” of the mispredicted (e.g., IF-guarded and/or subsequent) code. Some examples may choose to leave the determination to software. Combination of hardware and software cost modeling is also feasible.

By using Jcc_MH², a compiler (and ASM programmers) can become more aggressive in mask-all-zero bypass insertion in bypassing a section of code. In certain examples, if the mispredicted (e.g., IF-guarded) code is large relative to latency of conditional branch resolution and OOO capacity of the hardware, continuation of the execution of “the wrong path” can be harmful in both performance and power. Under those circumstances, compiler, ASM programmer, and/or hardware can choose not to utilize a Jcc_MH².

In certain examples where an application's performance suffers from the misprediction penalties arising from a conditional branch around functionally harmless code that can be executed unconditionally, a conditional branch with misprediction handling hint instruction (e.g., Jcc_MH²) offers significant gains in performance and power, e.g., including a new class of Conditional Branches with a Hint for misprediction handling and allowing for not cancelling instructions when branch is found to be mispredicted.

Exemplary architectures, systems, etc. that the above may be used in are detailed below. Exemplary instruction formats that may cause any of the operations herein are detailed below.

At least some examples of the disclosed technologies can be described in view of the following examples:
Example 1. An apparatus comprising:
a retirement circuit;
a branch predictor circuit to predict a predicted path for a branch, and cause a speculative processing of the predicted path (e.g., without causing a speculative processing of the not-predicted path for the branch);
a decode circuit to decode a single instruction into a decoded instruction, the single instruction having a field to indicate whether the retirement circuit is to allow retirement (e.g., making the results architecturally visible (e.g., not rolling back)) of the predicted path for the branch that is a misprediction; and
an execution circuit to execute the decoded instruction to cause:
   the retirement circuit to allow the retirement of the predicted path that is the misprediction for the branch when the field is set to a first value (for example, a multiple bit value, e.g., with one bit position of the multiple bit value for the predicted taken path and another bit position of the multiple bit value for the predicted not-taken path), and
   the retirement circuit to disallow the retirement of the predicted path that is the misprediction for the branch when the field is otherwise (e.g., the field is set to a second different value or the field is not present in the single instruction).
Example 2. The apparatus of example 1, wherein the field, when set to the first value, causes the retirement circuit to allow retirement of a predicted taken path that is the misprediction for the branch.
Example 3. The apparatus of example 2, wherein the field, when set to the first value, causes the retirement circuit to disallow retirement of a predicted not-taken path that is the misprediction for the branch.
Example 4. The apparatus of any one of examples 1-3, wherein the field, when set to the first value, causes the retirement circuit to allow retirement of a predicted not-taken path that is the misprediction for the branch.
Example 5. The apparatus of example 4, wherein the field, when set to the first value, causes the retirement circuit to disallow retirement of a predicted taken path that is the misprediction for the branch.
Example 6. The apparatus of any one of examples 1-5, wherein the retirement circuit is to disallow the retirement of the predicted path that is the misprediction for the branch when the field is otherwise by causing cancelation of the speculative processing of the single instruction.
Example 7. The apparatus of any one of examples 1-6, wherein the field is a prefix of the single instruction.
Example 8. The apparatus of any one of examples 1-6, wherein the field is an immediate operand of the single instruction.
Example 9. A method comprising:
predicting, by a branch predictor circuit, a predicted path for a branch;
causing, by the branch predictor circuit, a speculative processing of the predicted path;
decoding, by a decoder circuit, a single instruction into a decoded instruction, the single instruction having a field to indicate whether a retirement circuit is to allow retirement of the predicted path for the branch that is a misprediction; and
executing, by an execution circuit, the decoded instruction to cause:
   the retirement circuit to allow the retirement of the predicted path that is the misprediction for the branch when the field is set to a first value, and
   the retirement circuit to disallow the retirement of the predicted path that is the misprediction for the branch when the field is otherwise.
Example 10. The method of example 9, wherein the field, when set to the first value, causes the retirement circuit to allow retirement of a predicted taken path that is the misprediction for the branch.
Example 11. The method of example 10, wherein the field, when set to the first value, causes the retirement circuit to disallow retirement of a predicted not-taken path that is the misprediction for the branch.
Example 12. The method of example 9, wherein the field, when set to the first value, causes the retirement circuit to allow retirement of a predicted not-taken path that is the misprediction for the branch.
Example 13. The method of example 12, wherein the field, when set to the first value, causes the retirement circuit to disallow retirement of a predicted taken path that is the misprediction for the branch.
Example 14. The method of example 9, wherein the retirement circuit disallows the retirement of the predicted path that is the misprediction for the branch when the field is otherwise by causing cancelation of the speculative processing of the single instruction.
Example 15. The method of example 9, wherein the field is a prefix of the single instruction.
Example 16. The method of example 9, wherein the field is an immediate operand of the single instruction.
Example 17. A non-transitory machine-readable medium that stores code that when executed by a machine, wherein the machine comprises a retirement circuit and a branch predictor circuit to predict a predicted path for a branch and cause a speculative processing of the predicted path, causes the machine to perform a method comprising:
decoding, by a decoder circuit, a single instruction into a decoded instruction, the single instruction having a field to indicate whether the retirement circuit is to allow retirement of the predicted path for the branch that is a misprediction; and
executing, by an execution circuit, the decoded instruction to cause:
   the retirement circuit to allow the retirement of the predicted path that is the misprediction for the branch when the field is set to a first value, and
   the retirement circuit to disallow the retirement of the predicted path that is the misprediction for the branch when the field is otherwise.
Example 18. The non-transitory machine-readable medium of example 17, wherein the field, when set to the first value, causes the retirement circuit to allow retirement of a predicted taken path that is the misprediction for the branch.
Example 19. The non-transitory machine-readable medium of example 18, wherein the field, when set to the first value, causes the retirement circuit to disallow retirement of a predicted not-taken path that is the misprediction for the branch.
Example 20. The non-transitory machine-readable medium of example 17, wherein the field, when set to the first value, causes the retirement circuit to allow retirement of a predicted not-taken path that is the misprediction for the branch.
Example 21. The non-transitory machine-readable medium of example 20, wherein the field, when set to the first value, causes the retirement circuit to disallow retirement of a predicted taken path that is the misprediction for the branch.
Example 22. The non-transitory machine-readable medium of example 17, wherein the retirement circuit disallows the retirement of the predicted path that is the misprediction for the branch when the field is otherwise by causing cancelation of the speculative processing of the single instruction.
Example 23. The non-transitory machine-readable medium of example 17, wherein the field is a prefix of the single instruction.
Example 24. The non-transitory machine-readable medium of example 17, wherein the field is an immediate operand of the single instruction.

### Example Computer Architectures

Detailed below are descriptions of example computer architectures. Other system designs and configurations known in the arts for laptop, desktop, and handheld personal computers.

(PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

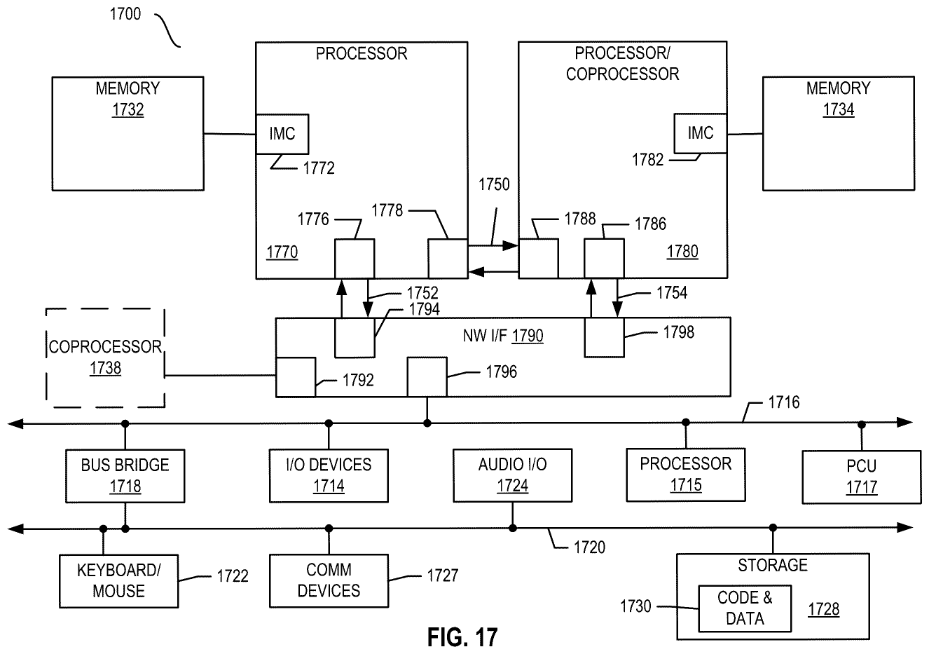

FIG. 17 illustrates an example computing system. Multiprocessor system 1700 is an interfaced system and includes a plurality of processors or cores including a first processor 1770 and a second processor 1780 coupled via an interface 1750 such as a point-to-point (P-P) interconnect, a fabric, and/or bus. In some examples, the first processor 1770 and the second processor 1780 are homogeneous. In some examples, first processor 1770 and the second processor 1780 are heterogenous. Though the example system 1700 is shown to have two processors, the system may have three or more processors, or may be a single processor system. In some examples, the computing system is a system on a chip (SoC).

Processors 1770 and 1780 are shown including integrated memory controller (IMC) circuitry 1772 and 1782, respectively. Processor 1770 also includes interface circuits 1776 and 1778; similarly, second processor 1780 includes interface circuits 1786 and 1788. Processors 1770, 1780 may exchange information via the interface 1750 using interface circuits 1778, 1788. IMCs 1772 and 1782 couple the processors 1770, 1780 to respective memories, namely a memory 1732 and a memory 1734, which may be portions of main memory locally attached to the respective processors.

Processors 1770, 1780 may each exchange information with a network interface (NW I/F) 1790 via individual interfaces 1752, 1754 using interface circuits 1776, 1794, 1786, 1798. The network interface 1790 (e.g., one or more of an interconnect, bus, and/or fabric, and in some examples is a chipset) may optionally exchange information with a coprocessor 1738 via an interface circuit 1792. In some examples, the coprocessor 1738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1770, 1780 or outside of both processors, yet connected with the processors via an interface such as P-P interconnect, such that either or both processors' local cache information may be stored in the shared cache if a processor is placed into a low power mode.

Network interface 1790 may be coupled to a first interface 1716 via interface circuit 1796. In some examples, first interface 1716 may be an interface such as a Peripheral Component Interconnect (PCI) interconnect, a PCI Express interconnect or another I/O interconnect. In some examples, first interface 1716 is coupled to a power control unit (PCU) 1717, which may include circuitry, software, and/or firmware to perform power management operations with regard to the processors 1770, 1780 and/or co-processor 1738. PCU 1717 provides control information to a voltage regulator (not shown) to cause the voltage regulator to generate the appropriate regulated voltage. PCU 1717 also provides control information to control the operating voltage generated. In various examples, PCU 1717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1717 is illustrated as being present as logic separate from the processor 1770 and/or processor 1780. In other cases, PCU 1717 may execute on a given one or more of cores (not shown) of processor 1770 or 1780. In some cases, PCU 1717 may be implemented as a microcontroller (dedicated or general-purpose) or other control logic configured to execute its own dedicated power management code, sometimes referred to as P-code. In yet other examples, power management operations to be performed by PCU 1717 may be implemented externally to a processor, such as by way of a separate power management integrated circuit (PMIC) or another component external to the processor. In yet other examples, power management operations to be performed by PCU 1717 may be implemented within BIOS or other system software.

Various I/O devices 1714 may be coupled to first interface 1716, along with a bus bridge 1718 which couples first interface 1716 to a second interface 1720. In some examples, one or more additional processor(s) 1715, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 1716. In some examples, second interface 1720 may be a low pin count (LPC) interface. Various devices may be coupled to second interface 1720 including, for example, a keyboard and/or mouse 1722, communication devices 1727 and storage circuitry 1728. Storage circuitry 1728 may be one or more non-transitory machine-readable storage media as described below, such as a disk drive or other mass storage device which may include instructions/code and data 1730 and may implement the storage 1103 in some examples. Further, an audio I/O 1724 may be coupled to second interface 1720. Note that other architectures than the point-to-point architecture described above are possible. For example, instead of the point-to-point architecture, a system such as multiprocessor system 1700 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

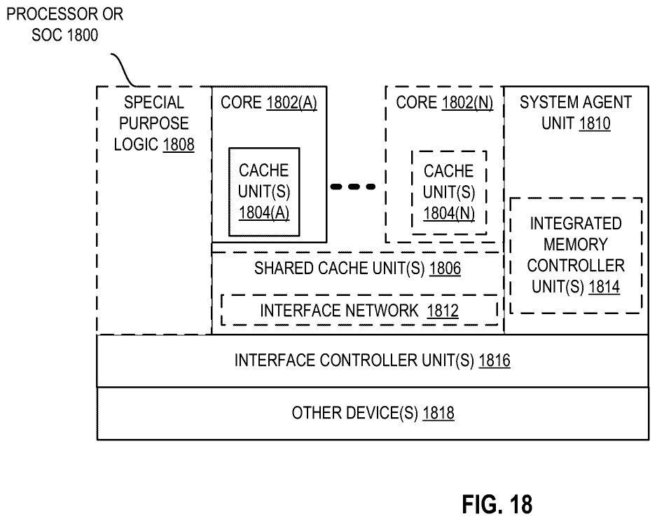

FIG. 18 illustrates a block diagram of an example processor and/or SoC 1800 that may have one or more cores and an integrated memory controller. The solid lined boxes illustrate a processor 1800 with a single core 1802(A), system agent unit circuitry 1810, and a set of one or more interface controller unit(s) circuitry 1816, while the optional addition of the dashed lined boxes illustrates an alternative processor 1800 with multiple cores 1802(A)-(N), a set of one or more integrated memory controller unit(s) circuitry 1814 in the system agent unit circuitry 1810, and special purpose logic 1808, as well as a set of one or more interface controller units circuitry 1816. Note that the processor 1800 may be one of the processors 1770 or 1780, or co-processor 1738 or 1715 of FIG. 17.

Thus, different implementations of the processor 1800 may include: 1) a CPU with the special purpose logic 1808 being integrated graphics and/or scientific (throughput) logic (which may include one or more cores, not shown), and the cores 1802(A)-(N) being one or more general purpose cores (e.g., general purpose in-order cores, general purpose out-of-order cores, or a combination of the two); 2) a coprocessor with the cores 1802(A)-(N) being a large number of special purpose cores intended primarily for graphics and/or scientific (throughput); and 3) a coprocessor with the cores 1802(A)-(N) being a large number of general purpose in-order cores. Thus, the processor 1800 may be a general-purpose processor, coprocessor, or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 1800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1804(A)-(N) within the cores 1802(A)-(N), a set of one or more shared cache unit(s) circuitry 1806, and external memory (not shown) coupled to the set of integrated memory controller unit(s) circuitry 1814. The set of one or more shared cache unit(s) circuitry 1806 may include one or more mid-level caches, such as level 2 (L2), level 3 (L3), level 4 (L4), or other levels of cache, such as a last level cache (LLC), and/or combinations thereof. While in some examples interface network circuitry 1812 (e.g., a ring interconnect) interfaces the special purpose logic 1808 (e.g., integrated graphics logic), the set of shared cache unit(s) circuitry 1806, and the system agent unit circuitry 1810, alternative examples use any number of well-known techniques for interfacing such units. In some examples, coherency is maintained between one or more of the shared cache unit(s) circuitry 1806 and cores 1802(A)-(N). In some examples, interface controller units circuitry 1816 couple the cores 1802 to one or more other devices 1818 such as one or more I/O devices, storage, one or more communication devices (e.g., wireless networking, wired networking, etc.), etc.

In some examples, one or more of the cores 1802(A)-(N) are capable of multi-threading. The system agent unit circuitry 1810 includes those components coordinating and operating cores 1802(A)-(N). The system agent unit circuitry 1810 may include, for example, power control unit (PCU) circuitry and/or display unit circuitry (not shown). The PCU may be or may include logic and components needed for regulating the power state of the cores 1802(A)-(N) and/or the special purpose logic 1808 (e.g., integrated graphics logic). The display unit circuitry is for driving one or more externally connected displays.

The cores 1802(A)-(N) may be homogenous in terms of instruction set architecture (ISA). Alternatively, the cores 1802(A)-(N) may be heterogeneous in terms of ISA; that is, a subset of the cores 1802(A)-(N) may be capable of executing an ISA, while other cores may be capable of executing only a subset of that ISA or another ISA.

### Example Core Architectures—In-Order and Out-of-Order Core Block Diagram

FIG. 19A is a block diagram illustrating both an example in-order pipeline and an example register renaming, out-of-order issue/execution pipeline according to examples. FIG. 19B is a block diagram illustrating both an example in-order architecture core and an example register renaming, out-of-order issue/execution architecture core to be included in a processor according to examples. The solid lined boxes in FIGS. 19A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 19A, a processor pipeline 1900 includes a fetch stage 1902, an optional length decoding stage 1904, a decode stage 1906, an optional allocation (Alloc) stage 1908, an optional renaming stage 1910, a schedule (also known as a dispatch or issue) stage 1912, an optional register read/memory read stage 1914, an execute stage 1916, a write back/memory write stage 1918, an optional exception handling stage 1922, and an optional commit stage 1924. One or more operations can be performed in each of these processor pipeline stages. For example, during the fetch stage 1902, one or more instructions are fetched from instruction memory, and during the decode stage 1906, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1906 and the register read/memory read stage 1914 may be combined into one pipeline stage. In one example, during the execute stage 1916, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 19B may implement the pipeline 1900 as follows: 1) the instruction fetch circuitry 1938 performs the fetch and length decoding stages 1902 and 1904; 2) the decode circuitry 1940 performs the decode stage 1906; 3) the rename/allocator unit circuitry 1952 performs the allocation stage 1908 and renaming stage 1910; 4) the scheduler(s) circuitry 1956 performs the schedule stage 1912; 5) the physical register file(s) circuitry 1958 and the memory unit circuitry 1970 perform the register read/memory read stage 1914; the execution cluster(s) 1960 perform the execute stage 1916; 6) the memory unit circuitry 1970 and the physical register file(s) circuitry 1958 perform the write back/memory write stage 1918; 7) various circuitry may be involved in the exception handling stage 1922; and 8) the retirement unit circuitry 1954 and the physical register file(s) circuitry 1958 perform the commit stage 1924.

FIG. 19B shows a processor core 1990 including front-end unit circuitry 1930 coupled to execution engine unit circuitry 1950, and both are coupled to memory unit circuitry 1970. The core 1990 may be a reduced instruction set architecture computing (RISC) core, a complex instruction set architecture computing (CISC) core, a very long instruction word (VLIW) core, or a hybrid or alternative core type. As yet another option, the core 1990 may be a special-purpose core, such as, for example, a network or communication core, compression engine, coprocessor core, general purpose computing graphics processing unit (GPGPU) core, graphics core, or the like.

The front-end unit circuitry 1930 may include branch prediction circuitry 1932 coupled to instruction cache circuitry 1934, which is coupled to an instruction translation lookaside buffer (TLB) 1936, which is coupled to instruction fetch circuitry 1938, which is coupled to decode circuitry 1940. In one example, the instruction cache circuitry 1934 is included in the memory unit circuitry 1970 rather than the front-end circuitry 1930. The decode circuitry 1940 (or decoder) may decode instructions, and generate as an output one or more micro-operations, microcode entry points, microinstructions, other instructions, or other control signals, which are decoded from, or which otherwise reflect, or are derived from, the original instructions. The decode circuitry 1940 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1940 may be implemented using various different mechanisms. Examples of suitable mechanisms include, but are not limited to, look-up tables, hardware implementations, programmable logic arrays (PLAs), microcode read only memories (ROMs), etc. In one example, the core 1990 includes a microcode ROM (not shown) or other medium that stores microcode for certain macroinstructions (e.g., in decode circuitry 1940 or otherwise within the front-end circuitry 1930). In one example, the decode circuitry 1940 includes a micro-operation (micro-op) or operation cache (not shown) to hold/cache decoded operations, micro-tags, or micro-operations generated during the decode or other stages of the processor pipeline 1900. The decode circuitry 1940 may be coupled to rename/allocator unit circuitry 1952 in the execution engine circuitry 1950.

The execution engine circuitry 1950 includes the rename/allocator unit circuitry 1952 coupled to retirement unit circuitry 1954 and a set of one or more scheduler(s) circuitry 1956. The scheduler(s) circuitry 1956 represents any number of different schedulers, including reservations stations, central instruction window, etc. In some examples, the scheduler(s) circuitry 1956 can include arithmetic logic unit (ALU) scheduler/scheduling circuitry, ALU queues, address generation unit (AGU) scheduler/scheduling circuitry, AGU queues, etc. The scheduler(s) circuitry 1956 is coupled to the physical register file(s) circuitry 1958. Each of the physical register file(s) circuitry 1958 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1958 includes vector registers unit circuitry, writemask registers unit circuitry, and scalar register unit circuitry. These register units may provide architectural vector registers, vector mask registers, general-purpose registers, etc. The physical register file(s) circuitry 1958 is coupled to the retirement unit circuitry 1954 (also known as a retire queue or a retirement queuc) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1954 and the physical register file(s) circuitry 1958 are coupled to the execution cluster(s) 1960. The execution cluster(s) 1960 includes a set of one or more execution unit(s) circuitry 1962 and a set of one or more memory access circuitry 1964. The execution unit(s) circuitry 1962 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1956, physical register file(s) circuitry 1958, and execution cluster(s) 1960 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1964). It should also be understood that where separate pipelines are used, one or more of these pipelines may be out-of-order issue/execution and the rest in-order.

In some examples, the execution engine unit circuitry 1950 may perform load store unit (LSU) address/data pipelining to an Advanced Microcontroller Bus (AMB) interface (not shown), and address phase and writeback, data phase load, store, and branches.

The set of memory access circuitry 1964 is coupled to the memory unit circuitry 1970, which includes data TLB circuitry 1972 coupled to data cache circuitry 1974 coupled to level 2 (L2) cache circuitry 1976. In one example, the memory access circuitry 1964 may include load unit circuitry, store address unit circuitry, and store data unit circuitry, each of which is coupled to the data TLB circuitry 1972 in the memory unit circuitry 1970. The instruction cache circuitry 1934 is further coupled to the level 2 (L2) cache circuitry 1976 in the memory unit circuitry 1970. In one example, the instruction cache 1934 and the data cache 1974 are combined into a single instruction and data cache (not shown) in L2 cache circuitry 1976, level 3 (L3) cache circuitry (not shown), and/or main memory. The L2 cache circuitry 1976 is coupled to one or more other levels of cache and eventually to a main memory.

The core 1990 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1990 includes logic to support a packed data instruction set architecture extension (e.g., AVX1, AVX2), thereby allowing the operations used by many multimedia applications to be performed using packed data.

### Example Execution Unit(s) Circuitry

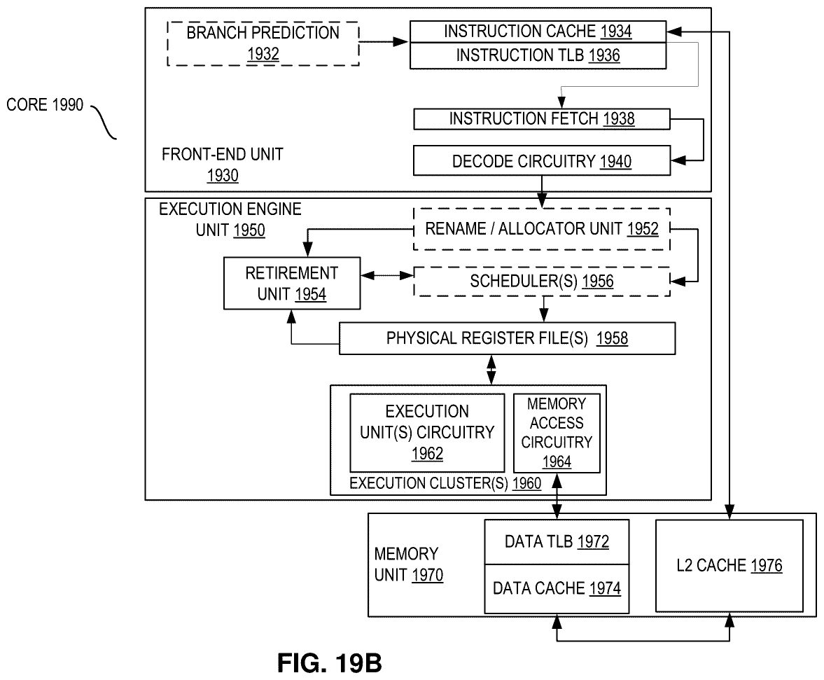

FIG. 20 illustrates examples of execution unit(s) circuitry, such as execution unit(s) circuitry 1962 of FIG. 19B. As illustrated, execution unit(s) circuitry 1962 may include one or more ALU circuits 2001, optional vector/single instruction multiple data (SIMD) circuits 2003, load/store circuits 2005, branch/jump circuits 2007, and/or Floating-point unit (FPU) circuits 2009. ALU circuits 2001 perform integer arithmetic and/or Boolean operations. Vector/SIMD circuits 2003 perform vector/SIMD operations on packed data (such as SIMD/vector registers). Load/store circuits 2005 execute load and store instructions to load data from memory into registers or store from registers to memory. Load/store circuits 2005 may also generate addresses. Branch/jump circuits 2007 cause a branch or jump to a memory address depending on the instruction. FPU circuits 2009 perform floating-point arithmetic. The width of the execution unit(s) circuitry 1962 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture

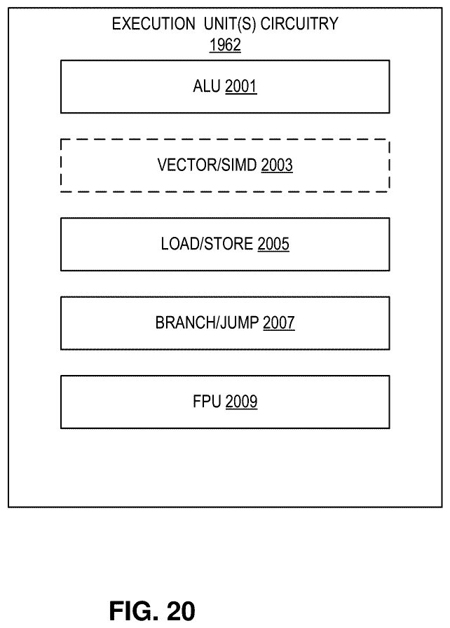

FIG. 21 is a block diagram of a register architecture 2100 according to some examples. As illustrated, the register architecture 2100 includes vector/SIMD registers 2110 that vary from 128-bit to 1,024 bits width. In some examples, the vector/SIMD registers 2110 are physically 512-bits and, depending upon the mapping, only some of the lower bits are used. For example, in some examples, the vector/SIMD registers 2110 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 2100 includes writemask/predicate registers 2115. For example, in some examples, there are 8 writemask/predicate registers (sometimes called k0 through k7) that are each 16-bit, 32-bit, 64-bit, or 128-bit in size. Writemask/predicate registers 2115 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, cach data element position in a given writemask/predicate register 2115 corresponds to a data element position of the destination. In other examples, the writemask/predicate registers 2115 are scalable and consists of a set number of enable bits for a given vector element (e.g., 8 enable bits per 64-bit vector element).

The register architecture 2100 includes a plurality of general-purpose registers 2125. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 2100 includes scalar floating-point (FP) register file 2145 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 2140 (e.g., EFLAGS, RFLAGS, etc.) store status and control information for arithmetic, compare, and system operations. For example, the one or more flag registers 2140 may store condition code information such as carry, parity, auxiliary carry, zero, sign, and overflow. In some examples, the one or more flag registers 2140 are called program status and control registers.

Segment registers 2120 contain segment points for use in accessing memory. In some examples, these registers are referenced by the names CS, DS, SS, ES, FS, and GS.

Machine specific registers (MSRs) 2135 control and report on processor performance. Most MSRs 2135 handle system-related functions and are not accessible to an application program. Machine check registers 2160 consist of control, status, and error reporting MSRs that are used to detect and report on hardware errors.

One or more instruction pointer register(s) 2130 store an instruction pointer value. Control register(s) 2155 (e.g., CR0-CR4) determine the operating mode of a processor (e.g., processor 1770, 1780, 1738, 1715, and/or 1800) and the characteristics of a currently executing task. Debug registers 2150 control and allow for the monitoring of a processor or core's debugging operations.

Memory (mem) management registers 2165 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 2100 may, for example, be used in register file/memory 1108, or physical register file(s) circuitry 1958.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source 1/destination and source 2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

FIG. 22 illustrates examples of an instruction format. As illustrated, an instruction may include multiple components including, but not limited to, one or more fields for: one or more prefixes 2201, an opcode 2203, addressing information 2205 (e.g., register identifiers, memory addressing information, etc.), a displacement value 2207, and/or an immediate value 2209. Note that some instructions utilize some or all the fields of the format whereas others may only use the field for the opcode 2203. In some examples, the order illustrated is the order in which these fields are to be encoded, however, it should be appreciated that in other examples these fields may be encoded in a different order, combined, etc.

The prefix(es) field(s) 2201, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 2203 is used to at least partially define the operation to be performed upon a decoding of the instruction. In some examples, a primary opcode encoded in the opcode field 2203 is one, two, or three bytes in length. In other examples, a primary opcode can be a different length. An additional 3-bit opcode field is sometimes encoded in another field.

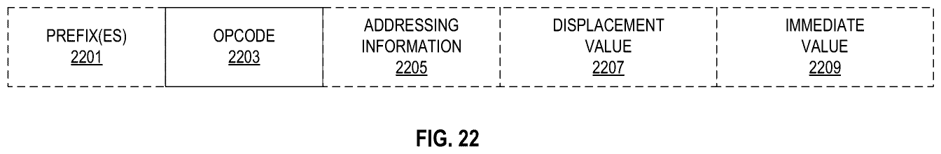

The addressing information field 2205 is used to address one or more operands of the instruction, such as a location in memory or one or more registers. FIG. 23 illustrates examples of the addressing information field 2205. In this illustration, an optional MOD R/M byte 2302 and an optional Scale, Index, Base (SIB) byte 2304 are shown. The MOD R/M byte 2302 and the SIB byte 2304 are used to encode up to two operands of an instruction, each of which is a direct register or effective memory address. Note that both of these fields are optional in that not all instructions include one or more of these fields. The MOD R/M byte 2302 includes a MOD field 2342, a register (reg) field 2344, and R/M field 2346.

The content of the MOD field 2342 distinguishes between memory access and non-memory access modes. In some examples, when the MOD field 2342 has a binary value of 11 (11b), a register-direct addressing mode is utilized, and otherwise a register-indirect addressing mode is used.

The register field 2344 may encode either the destination register operand or a source register operand or may encode an opcode extension and not be used to encode any instruction operand. The content of register field 2344, directly or through address generation, specifies the locations of a source or destination operand (either in a register or in memory). In some examples, the register field 2344 is supplemented with an additional bit from a prefix (e.g., prefix 2201) to allow for greater addressing.

The R/M field 2346 may be used to encode an instruction operand that references a memory address or may be used to encode either the destination register operand or a source register operand. Note the R/M field 2346 may be combined with the MOD field 2342 to dictate an addressing mode in some examples.

The SIB byte 2304 includes a scale field 2352, an index field 2354, and a base field 2356 to be used in the generation of an address. The scale field 2352 indicates a scaling factor. The index field 2354 specifies an index register to use. In some examples, the index field 2354 is supplemented with an additional bit from a prefix (e.g., prefix 2201) to allow for greater addressing. The base field 2356 specifies a base register to use. In some examples, the base field 2356 is supplemented with an additional bit from a prefix (e.g., prefix 2201) to allow for greater addressing. In practice, the content of the scale field 2352 allows for the scaling of the content of the index field 2354 for memory address generation (e.g., for address generation that uses 2^{scale}*index+base).

Some addressing forms utilize a displacement value to generate a memory address. For example, a memory address may be generated according to 2scale*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 2207 provides this value. Additionally, in some examples, a displacement factor usage is encoded in the MOD field of the addressing information field 2205 that indicates a compressed displacement scheme for which a displacement value is calculated and stored in the displacement field 2207.

In some examples, the immediate value field 2209 specifies an immediate value for the instruction. An immediate value may be encoded as a 1-byte value, a 2-byte value, a 4-byte value, etc.

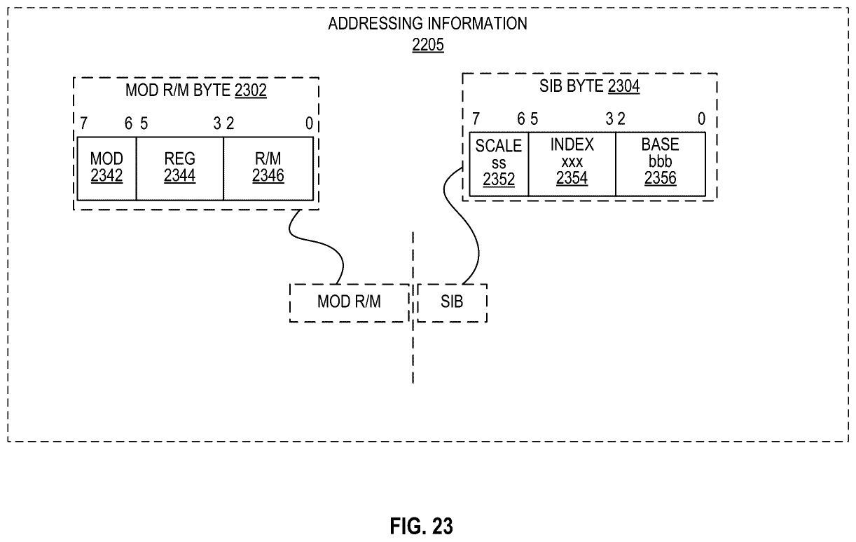

FIG. 24 illustrates examples of a first prefix 2201(A). In some examples, the first prefix 2201(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 2201(A) may specify up to three registers using 3-bit fields depending on the format: 1) using the reg field 2344 and the R/M field 2346 of the MOD R/M byte 2302; 2) using the MOD R/M byte 2302 with the SIB byte 2304 including using the reg field 2344 and the base field 2356 and index field 2354; or 3) using the register field of an opcode.

In the first prefix 2201(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (24) registers to be addressed, whereas the MOD R/M reg field 2344 and MOD R/M R/M field 2346 alone can each only address 8 registers.

In the first prefix 2201(A), bit position 2 (R) may be an extension of the MOD R/M reg field 2344 and may be used to modify the MOD R/M reg field 2344 when that field encodes a general-purpose register, a 64-bit packed data register (e.g., an SSE register), or a control or debug register. R is ignored when MOD R/M byte 2302 specifies other registers or defines an extended opcode.

Bit position 1 (X) may modify the SIB byte index field 2354.

Bit position 0 (B) may modify the base in the MOD R/M R/M field 2346 or the SIB byte base field 2356; or it may modify the opcode register field used for accessing general purpose registers (e.g., general purpose registers 2125).

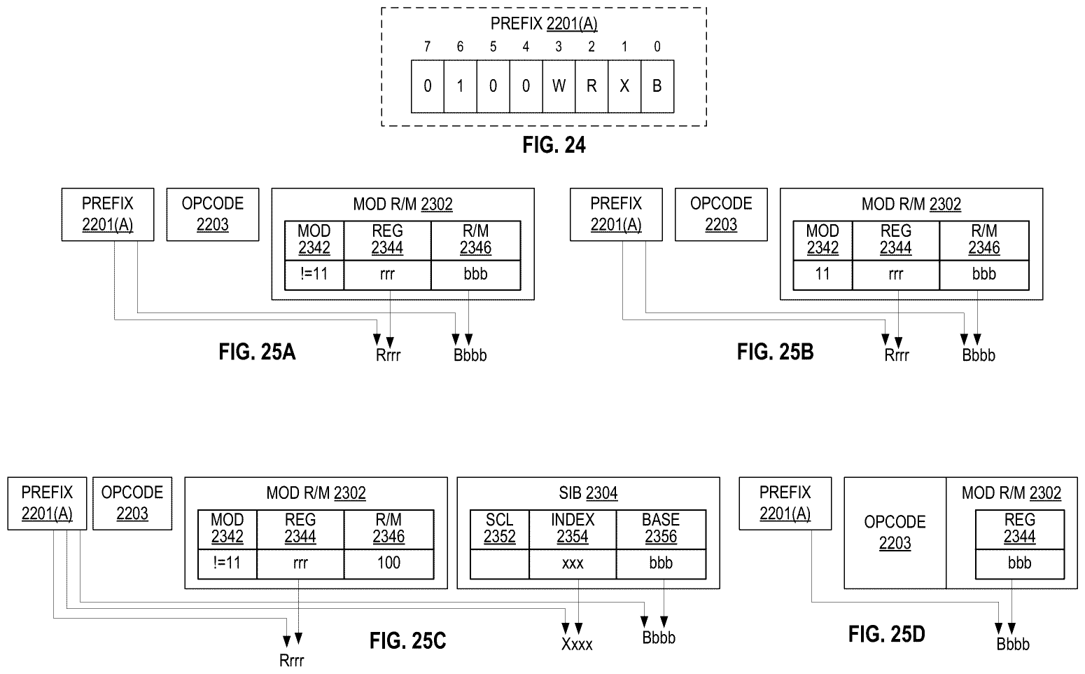

FIGS. 25A-D illustrate examples of how the R, X, and B fields of the first prefix 2201(A) are used. FIG. 25A illustrates R and B from the first prefix 2201(A) being used to extend the reg field 2344 and R/M field 2346 of the MOD R/M byte 2302 when the SIB byte 2304 is not used for memory addressing. FIG. 25B illustrates R and B from the first prefix 2201(A) being used to extend the reg field 2344 and R/M field 2346 of the MOD R/M byte 2302 when the SIB byte 2304 is not used (register-register addressing). FIG. 25C illustrates R, X, and B from the first prefix 2201(A) being used to extend the reg field 2344 of the MOD R/M byte 2302 and the index field 2354 and base field 2356 when the SIB byte 2304 being used for memory addressing. FIG. 25D illustrates B from the first prefix 2201(A) being used to extend the reg field 2344 of the MOD R/M byte 2302 when a register is encoded in the opcode 2203.

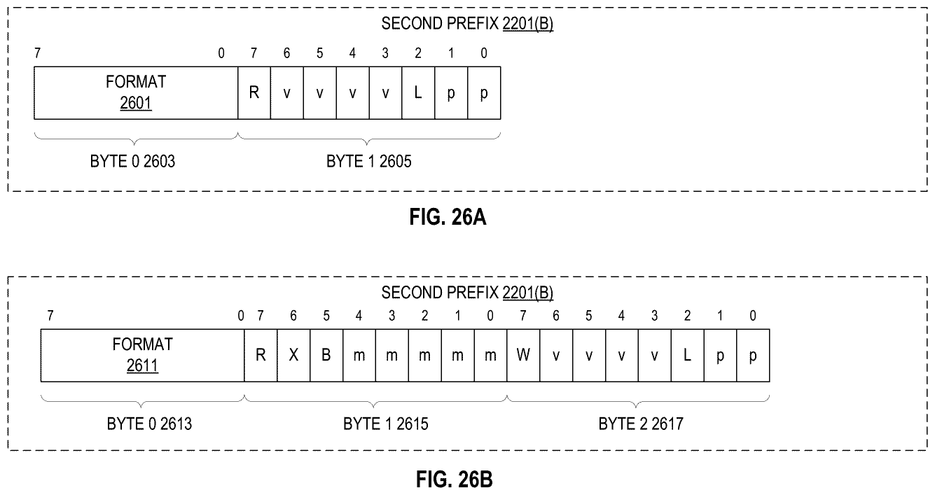

FIGS. 26A-B illustrate examples of a second prefix 2201(B). In some examples, the second prefix 2201(B) is an example of a VEX prefix. The second prefix 2201(B) encoding allows instructions to have more than two operands, and allows SIMD vector registers (e.g., vector/SIMD registers 2110) to be longer than 64-bits (e.g., 128-bit and 256-bit). The use of the second prefix 2201(B) provides for three-operand (or more) syntax. For example, previous two-operand instructions performed operations such as A=A+B, which overwrites a source operand. The use of the second prefix 2201(B) enables operands to perform nondestructive operations such as A=B+C.

In some examples, the second prefix 2201(B) comes in two forms—a two-byte form and a three-byte form. The two-byte second prefix 2201(B) is used mainly for 128-bit, scalar, and some 256-bit instructions; while the three-byte second prefix 2201(B) provides a compact replacement of the first prefix 2201(A) and 3-byte opcode instructions.

FIG. 26A illustrates examples of a two-byte form of the second prefix 2201(B). In one example, a format field 2601 (byte 0 2603) contains the value C5H. In one example, byte 1 2605 includes an “R” value in bit[7]. This value is the complement of the “R” value of the first prefix 2201(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in Is complement form for certain vector shifts; or 3) not encode any operand, the field is reserved and should contain a certain value, such as 1111b.

Instructions that use this prefix may use the MOD R/M R/M field 2346 to encode the instruction operand that references a memory address or encode either the destination register operand or a source register operand.

Instructions that use this prefix may use the MOD R/M reg field 2344 to encode either the destination register operand or a source register operand, or to be treated as an opcode extension and not used to encode any instruction operand.

For instruction syntax that support four operands, vvvv, the MOD R/M R/M field 2346 and the MOD R/M reg field 2344 encode three of the four operands. Bits[7:4] of the immediate value field 2209 are then used to encode the third source register operand.

FIG. 26B illustrates examples of a three-byte form of the second prefix 2201(B). In one example, a format field 2611 (byte 0 2613) contains the value C4H. Byte 1 2615 includes in bits [7:5] “R,” “X,” and “B” which are the complements of the same values of the first prefix 2201(A). Bits[4:0] of byte 1 2615 (shown as mmmmm) include content to encode, as need, one or more implied leading opcode bytes. For example, 00001 implies a OFH leading opcode, 00010 implies a 0F38H leading opcode, 00011 implies a 0F3AH leading opcode, etc.

Bit[7] of byte 2 2617 is used similar to W of the first prefix 2201(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 2346 to encode the instruction operand that references a memory address or encode either the destination register operand or a source register operand.

Instructions that use this prefix may use the MOD R/M reg field 2344 to encode either the destination register operand or a source register operand, or to be treated as an opcode extension and not used to encode any instruction operand.

For instruction syntax that support four operands, vvvv, the MOD R/M R/M field 2346, and the MOD R/M reg field 2344 encode three of the four operands. Bits[7:4] of the immediate value field 2209 are then used to encode the third source register operand.

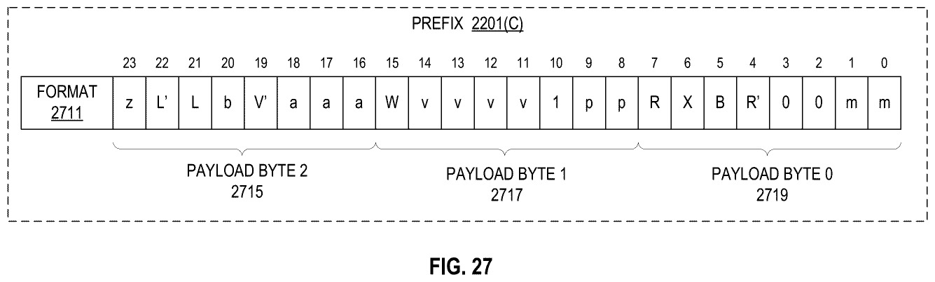

FIG. 27 illustrates examples of a third prefix 2201(C). In some examples, the third prefix 2201(C) is an example of an EVEX prefix. The third prefix 2201(C) is a four-byte prefix.

The third prefix 2201(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 21) or predication utilize this prefix. Opmask register allow for conditional processing or selection control. Opmask instructions, whose source/destination operands are opmask registers and treat the content of an opmask register as a single value, are encoded using the second prefix 2201(B).

The third prefix 2201(C) may encode functionality that is specific to instruction classes (e.g., a packed instruction with “loadtop” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 2201(C) is a format field 2711 that has a value, in one example, of 62H. Subsequent bytes are referred to as payload bytes 2715-2719 and collectively form a 24-bit value of P[23:0] providing specific capability in the form of one or more fields (detailed herein).

In some examples, P[1:0] of payload byte 2719 are identical to the low two mm bits. P[3:2] are reserved in some examples. Bit P[4] (R′) allows access to the high 16 vector register set when combined with P[7] and the MOD R/M reg field 2344. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 2344 and MOD R/M R/M field 2346. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in Is complement form for certain vector shifts; or 3) not encode any operand, the field is reserved and should contain a certain value, such as 1111b.

P[15] is similar to W of the first prefix 2201(A) and second prefix 2211(B) and may serve as an opcode extension bit or operand size promotion. P[18:16] specify the index of a register in the opmask (writemask) registers (e.g., writemask/predicate registers 2115). In one example, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 2201(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | MOD R/M | GPR, Vector | Destination or Source |
| | | | reg | | |
| VVVV | V′ | vvvv | | GPR, Vector | 2nd Source or |
| | | | | | Destination |
| RM | X | B | MOD R/M | GPR, Vector | 1st Source or |
| | | | R/M | | Destination |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1] | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 28 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 28 shows a program in a high-level language 2802 may be compiled using a first ISA compiler 2804 to generate first ISA binary code 2806 that may be natively executed by a processor with at least one first ISA core 2816. The processor with at least one first ISA core 2816 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 2804 represents a compiler that is operable to generate first ISA binary code 2806 (e.g., object code) that can, with or without additional linkage processing, be executed on the processor with at least one first ISA core 2816. Similarly. FIG. 28 shows the program in the high-level language 2802 may be compiled using an alternative ISA compiler 2808 to generate alternative ISA binary code 2810 that may be natively executed by a processor without a first ISA core 2814. The instruction converter 2812 is used to convert the first ISA binary code 2806 into code that may be natively executed by the processor without a first ISA core 2814. This converted code is not necessarily to be the same as the alternative ISA binary code 2810; however, the converted code will accomplish the general operation and be made up of instructions from the alternative ISA. Thus, the instruction converter 2812 represents software, firmware, hardware, or a combination thereof that, through emulation, simulation, or any other process, allows a processor or other electronic device that does not have a first ISA processor or core to execute the first ISA binary code 2806.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
a retirement circuit;
a branch predictor circuit to predict a predicted path for a branch, and cause a speculative processing of the predicted path;
a decode circuit to decode a single instruction into a decoded instruction, the single instruction having a field to indicate whether the retirement circuit is to allow retirement of the predicted path for the branch that is a misprediction; and
an execution circuit to execute the decoded instruction to cause:
the retirement circuit to allow the retirement of the predicted path that is the misprediction for the branch when the field is set to a first value, and
the retirement circuit to disallow the retirement of the predicted path that is the misprediction for the branch when the field is otherwise.

2. The apparatus of claim 1, wherein the field, when set to the first value, causes the retirement circuit to allow retirement of a predicted taken path that is the misprediction for the branch.

3. The apparatus of claim 2, wherein the field, when set to the first value, causes the retirement circuit to disallow retirement of a predicted not-taken path that is the misprediction for the branch.

4. The apparatus of claim 1, wherein the field, when set to the first value, causes the retirement circuit to allow retirement of a predicted not-taken path that is the misprediction for the branch.

5. The apparatus of claim 4, wherein the field, when set to the first value, causes the retirement circuit to disallow retirement of a predicted taken path that is the misprediction for the branch.

6. The apparatus of claim 1, wherein the retirement circuit is to disallow the retirement of the predicted path that is the misprediction for the branch when the field is otherwise by causing cancelation of the speculative processing of the single instruction.

7. The apparatus of claim 1, wherein the field is a prefix of the single instruction.

8. The apparatus of claim 1, wherein the field is an immediate operand of the single instruction.

9. A method comprising:
predicting, by a branch predictor circuit, a predicted path for a branch;
causing, by the branch predictor circuit, a speculative processing of the predicted path;
decoding, by a decoder circuit, a single instruction into a decoded instruction, the single instruction having a field to indicate whether a retirement circuit is to allow retirement of the predicted path for the branch that is a misprediction; and
executing, by an execution circuit, the decoded instruction to cause:
the retirement circuit to allow the retirement of the predicted path that is the misprediction for the branch when the field is set to a first value, and
the retirement circuit to disallow the retirement of the predicted path that is the misprediction for the branch when the field is otherwise.

10. The method of claim 9, wherein the field, when set to the first value, causes the retirement circuit to allow retirement of a predicted taken path that is the misprediction for the branch.

11. The method of claim 10, wherein the field, when set to the first value, causes the retirement circuit to disallow retirement of a predicted not-taken path that is the misprediction for the branch.

12. The method of claim 9, wherein the field, when set to the first value, causes the retirement circuit to allow retirement of a predicted not-taken path that is the misprediction for the branch.

13. The method of claim 12, wherein the field, when set to the first value, causes the retirement circuit to disallow retirement of a predicted taken path that is the misprediction for the branch.

14. The method of claim 9, wherein the retirement circuit disallows the retirement of the predicted path that is the misprediction for the branch when the field is otherwise by causing cancelation of the speculative processing of the single instruction.

15. The method of claim 9, wherein the field is a prefix of the single instruction.

16. The method of claim 9, wherein the field is an immediate operand of the single instruction.

17. A non-transitory machine-readable medium that stores code that when executed by a machine, wherein the machine comprises a retirement circuit and a branch predictor circuit to predict a predicted path for a branch and cause a speculative processing of the predicted path, causes the machine to perform a method comprising:
decoding, by a decoder circuit, a single instruction into a decoded instruction, the single instruction having a field to indicate whether the retirement circuit is to allow retirement of the predicted path for the branch that is a misprediction; and
executing, by an execution circuit, the decoded instruction to cause:
the retirement circuit to allow the retirement of the predicted path that is the misprediction for the branch when the field is set to a first value, and
the retirement circuit to disallow the retirement of the predicted path that is the misprediction for the branch when the field is otherwise.

18. The non-transitory machine-readable medium of claim 17, wherein the field, when set to the first value, causes the retirement circuit to allow retirement of a predicted taken path that is the misprediction for the branch.

19. The non-transitory machine-readable medium of claim 18, wherein the field, when set to the first value, causes the retirement circuit to disallow retirement of a predicted not-taken path that is the misprediction for the branch.

20. The non-transitory machine-readable medium of claim 17, wherein the field, when set to the first value, causes the retirement circuit to allow retirement of a predicted not-taken path that is the misprediction for the branch.

21. The non-transitory machine-readable medium of claim 20, wherein the field, when set to the first value, causes the retirement circuit to disallow retirement of a predicted taken path that is the misprediction for the branch.

22. The non-transitory machine-readable medium of claim 17, wherein the retirement circuit disallows the retirement of the predicted path that is the misprediction for the branch when the field is otherwise by causing cancelation of the speculative processing of the single instruction.

23. The non-transitory machine-readable medium of claim 17, wherein the field is a prefix of the single instruction.

24. The non-transitory machine-readable medium of claim 17, wherein the field is an immediate operand of the single instruction.
